(19) United States
(12) Patent Application Publication
(10) Pub. No.: US 2007/0106674 A1
(43) Pub. Date: May 10, 2007

(54) FIELD SALES PROCESS FACILITATION SYSTEMS AND METHODS

(76) Inventors: Purusharth Agrawal, Austin, TX (US); Todd Young, Austin, TX (US)

Correspondence Address: H. Dale Langley, Jr.;The Law Office of H. Dale Langley, Jr., 610 West Lynn, Austin, TX, 78703, US

(21) Appl. No.: 11/557,568

(22) Filed: Nov. 8, 2006

Related U.S. Application Data
(60) Provisional application No. 60/735,337, filed on Nov. 10, 2005.

(51) Int. Cl. G06F 17/30

(52) U.S. Cl. 707/10

(57) ABSTRACT

An automated sales process facilitation tool includes a database. The database is connected to a communicative network. A communicative device of a salesperson is connected to the network. A token is input by the salesperson to and at the communicative device. The token is communicated through the network by the device to the database. The token has a value in a sales effort. The database receives over the network, and processes the token. The database attributes a credit corresponding to the value of the token. The database refines the value based on tokens received at the database. Information of the database relative to the sales process is accessible and viewable via the network from the database. The database ranks information according to respective value to the sales process that is attributed to each piece of information of the database. Each token having value to the sales process is populated in and included as the information of the database. The database corresponds a relative credit (such as based on value) to tokens contributed by salesperson users to the information of value populating the database. The credit, and subsets or aggregated credits for tokens so contributed to information of the database, are communicated over the network to the device for viewing credit score comparisons by the salesperson.

### CROSS-REFERENCE TO PRIORITY U.S. PROVISIONAL PATENT APPLICATION

The present application is a conversion of, and is related to and incorporates by reference herein, U.S. Provisional Patent Application No. 60/735,337, titled “Automated Sales Tool”, filed Nov. 10, 2005, of the same inventors hereof.

### BACKGROUND OF THE INVENTION

The present invention generally relates to sales and marketing tools and, more particularly, relates to systems and methods for automated sales process facilitation, guidance, steps, practices, management and customer dealings, including to improve sales practices, guide such practices, increase participation, cooperation, and teamwork, incentivize valuable input and teamwork, and otherwise promote and facilitate sales efforts and processes.

Teamwork, group and member cooperation, and coordinated efforts of multiple people are important in many situations in order to achieve best outcomes. In sports, for example, such as basketball, teams comprise multiple athletes each providing contribution to achieve results. Contributions of respective team members can sometimes be measured, at least in significant part, through objective statistical measures. For example, baskets, rebounds, blocks, attempts and other aspects of basketball play can be numerically determined/assessed and weighted in accordance with team motivations and desires. These aspects can be measured as to individual team members, and also aggregated for the entire team.

In other situations in which teamwork is considered desirable, the contribution of individuals for the benefit of the team is not so easily analyzed and measured. In situations where numerical or similar objective indicia of performance and actions are not readily determined or available, measuring contributions to teamwork and individual efforts for the team have often been primarily viewed by end results that may be subjectively perceived as attributable to only certain or single individuals. Sales forces within competitive companies present a prime example of instances in which teamwork is believed to be desirable, yet sales forces conventionally have rewarded primarily sales closings or other similar indicia of efforts that have some numerical semblance. Management must subjectively consider any other criteria of contribution by sales people (e.g. mentoring of less experienced team members, sharing of knowledge, assisting to resolve issues, etc.) and team efforts, and these considerations inevitably lead to criticism, dispute, disagreement, favoritism, inaccuracies, and the like by sales members.

There has conventionally been very limited, if any, measurement and tracking capabilities for more objectively and fairly assessing teamwork and team contribution in these situations, particularly in sales forces. The measurement has not been automated and consistent, and the tracking has been ad hoc at best. As a result, objective indicia and measurement of individual contributions to sales and the like have been lacking. This has led to lack of cooperation, secretiveness, and overall failure of individual members to coordinate efforts as parts of the teams. Nonetheless, businesses and many other environments continue to maintain belief that teamwork is desired and essential to success, and continue to seek policies, procedures, and other efforts to further actions that lead to success of and through teams and teamwork.

Conventional automated sales and marketing management systems have been software database applications of customer contacts, addresses, and the like, and have provided searching features for the database. Other conventional systems have comprised physical paper files, calendars, and other tangible records, or combinations of manual and automated elements. Sales information input by salespersons in the database and records, and searchable or findable in these prior applications, has typically been inadequate as to accuracy, quality, quantity, and specific sales opportunity relevance.

Objectives of these conventional systems have focused on sales forecasting and sales process state/status (i.e., “pipeline” information reporting). The systems have been useful primarily for company management review. Focus of the systems has not particularly been facilitation of the field sales process and resourceful use by field salespersons actively involved in that process. Salesperson participation in populating the systems with relevant sale-specific types of information has been limited, and records and information available via these conventional systems is often inaccurate, lacks quality, and is limited in quantity. These problems largely result from the limited focus of objectives of such conventional systems, primarily for data storage and retrieval but not particularly sales process facilitation for use by salespersons. Because of the limited focus of objectives for the conventional systems, the usefulness of the systems for the intended objectives is hampered and therefore forecasting and the like via the information input into the systems by the salespersons is subject to significant error.

Further reasons for inadequacies of conventional systems have included that significant manpower of sales personnel, information technology managers, and others is required to input, maintain and update information of the systems. Also, sales personnel have historically been hesitant to share information and otherwise cooperate in sales activities. In fact, sharing, cooperation and other company teamwork sales efforts have been disincentivized by conventional systems and practices because of lack of any realizable advantages or rewards to salepersons for proper, accurate and consistent use of the systems. Moreover, complexity in and of participation has had no such significance or realizable gains to the salesperson to encourage participation. This is evidenced by the fact that salesperson compensation schemes typically tend to more greatly reward individualized sales results (e.g., sale closures, etc., via commissioned compensation) than emphasizing or recognizing any team or company-wide efforts or results. Thus, the required effort to input information combined with the lack of incentive to share such information has resulted in the lack of participation of salespersons in using and contributing to conventional automated and other customer and sales information and management tools.

Even where the conventional automated sales and marketing management systems have served some useful purpose in use by management within companies to assess sales success or statistics, the systems typically require voluntary participation of users, including any salespersons that use the systems. For example, salespersons choosing to use the conventional systems are typically not credited or otherwise awarded for use of the systems or sharing of information, cooperative efforts, and the like in connection with the systems and sales efforts. A reason for this has been that objective criteria for and merits to users of the conventional systems has not been measurable or weighable.

Although sales forces generally recognize there is great value of teamwork among salespersons, and attempt to promote such teamwork, compensation and incentives afforded to salespersons have been based largely on personal merit for sales consummated. Managers of salespersons can potentially assess salesperson contributions in making compensation and incentive decisions, however, the assessment is almost entirely subjective and in the discretion of the managers. At times and in certain situations companies attempt to award team efforts and the like, but these efforts are not easily or consistently objectively viewed. Effective and objective tracking of sales processes and sales efforts, including by individual salespersons, has been lacking. Certainly, any such tracking coupled with particular sales process facilitation would benefit salespersons, on both an individual and collective basis, and would provide benefits to sales forces and companies having such coupled capabilities. Combinations of tracking and sales process facilitation, as well as other nuances and options, would be desirable in automated systems and methods, including for promoting teamwork and morale and in encouraging sharing and availability of valuable, qualitative, and quantitative sales information.

Although others have provided conventional automated customer relations management (CRM) software (a type of automated application often sold as sales and marketing “tools”) used by salespersons in certain situations, this CRM software has had only limited functions and utility to salespersons in the field and in facilitating sales efforts and processes. In particular, the sales enabling functions of CRM software have primarily been limited to providing certain data storage for access to contacts and calendar/scheduling features. The software has not provided any particular tool or aid to further or facilitate sales processes and efforts of salespersons and the sales force as a team.

CRM software and other similar conventional sales “tools” have not facilitated the sales function/process, such as by driving sales, sales steps and efforts, and other conduct of making sales. Rather, the software has merely provided data storage and access. Of course, with such limited application, the CRM software has not had objectives of promoting, guiding, or shortening sales cycles, such as by reducing unsolicited sales phone calls (“cold calling”) and unsolicited e-mails, promoting best or uniform sales practices, guiding the sales steps through more relevant or effective processes, or making available opportunity-specific and particularly relevant customer-specific information. Instead, the conventional CRM applications have been basic databases and searching functions

Although the prior automated systems have not done so, it would be desirable and of significant benefit to salespersons and sales forces to promote the collection and input of very relevant and accurate sales facilitation data, such as relevant and valuable contacts, knowledge, information, materials and the like. This would make accessible the best and most valuable of such information for each particular sale opportunity, each potential customer, and each potential competitor. Salespersons, in particular, but also others involved in sales efforts and management, would find these benefits to be extremely desirable because they are geared to each particular sale and customer. Information of greatest value for each respective sales opportunity would thus be available to sales professionals, rather than merely generalized data and searching capabilities geared solely to contacts, scheduled dates and the like obtained from the conventional CRM and similar applications.

Thus, it would be a significant improvement in the art and technology to provide systems and methods for making sale-specific and customer-specific sales process facilitative information accessible to salespersons, providing a credibility evaluation mechanism behind such information, increasing participation and cooperation by salespersons in collection of such information, encouraging distribution of such information to others in the sales force (or other cooperative sales group, as applicable), objectively tracking and assessing salesperson efforts in participating in sale efforts in these regards, and promoting teamwork and morale through objective measures for advantages, awards and similar incentives to salespersons providing valuable participation. Nuances and improvements such as these and others will further and guide uniformly better sales practices throughout the sales force (or cooperative sales group, as applicable), and otherwise provide advantages and benefits through better and automated sales process facilitators.

### SUMMARY OF THE INVENTION

An embodiment of the invention is an automated sales process facilitation tool. The sales process facilitation tool includes a database of sales and sales process data, a network connected to the database, a first salesperson device connected to the network, capable of communicating a token to the database over the network and selectively retrieving to the device over the network a relevant data from among the sales and sales process data of the database, a second device connected to the network, capable of accessing the token and communicating a feedback data to the database, the feedback data representative of a value of the token, and a credit attributed to the value of the token by the database, the credit being maintained by the database. The database operatively ranks the token in accord with the value, to ensure qualitative and credible sales and sales process data of the database for successive database operations.

Another embodiment is a method of facilitating a sales process for a product. The method includes providing a database of sales and sales process data, communicating with the database over a network, directing the database to sort for a relevant subset of the sales and sales process data of the database, accessing the relevant subset over the network, evaluating a data of the relevant subset, communicating a feedback of a result of the step of evaluating, over the network to the database, processing the feedback to value the result, ranking the data of the relevant subset in accordance with the value from the step of processing, communicating a token having a value over the network to the database, storing the token as a new data of the sales and process data of the database, repeating the steps of evaluating, communicating feedback, processing and ranking as to the new data, accessing the new data as a portion of the relevant subset, crediting the token, in accordance with the value, varying the step of ranking after the step of processing, and varying the step of processing the feedback in accordance with a characteristic of the result.

Yet another embodiment is a method of obtaining a preferable sale data for a sales opportunity from among an aggregate of sales data of a database. The preferable sale data has a value to the sales opportunity. The method includes populating the database with the aggregate of sales data, the aggregate includes a first preferable sale data that is the preferable sale data, receiving a feedback by the database communicated over a network concerning the value to the sales opportunity of the first preferable sale data, revaluing the first preferable sale data with respect to the aggregate of sales data in response and in accordance to the feedback, ranking the first preferable sale data with respect to the aggregate of sales data based on the step of revaluing, and determining a second preferable sale data as the preferable sale data based on the step of ranking.

### BRIEF DESCRIPTION OF THE DRAWINGS

The present invention is illustrated by way of example and not limitation in the accompanying figures, in which like references indicate similar elements, and in which:

FIG. 1 illustrates an automated sales facilitation tool, according to certain embodiments of the invention;

FIG. 2 illustrates a method of selling products, according to certain embodiments of the invention;

FIG. 3 illustrates a database schema of a database of the automated sales facilitation tool of FIG. 1, according to certain embodiments of the invention;

FIG. 4 illustrates a method of implementing the automated sales facilitation tool and method of selling of FIGS. 1 and 2, according to certain embodiments of the invention;

FIG. 5 illustrates a method of initially populating a database of the automated sales facilitation tool of FIG. 1, according to certain embodiments of the invention;

FIG. 6 illustrates a method of populating the database of the automated sales facilitation tool of FIG. 1 with contacts, according to certain embodiments of the invention;

FIG. 7 illustrates a method of populating the database of the automated sales facilitation tool of FIG. 1 with sales information, according to certain embodiments of the invention;

FIG. 8 illustrates a method of crediting a sales effort and rectifying a sales information of the database of the automated sales facilitation tool of FIG. 1, according to certain embodiments of the invention;

FIG. 9 illustrates a concept block overview of an example of the automated sales facilitation tool of FIG. 1, operable as in FIGS. 1-8 and 27, according to certain embodiments of the invention;

FIG. 10 illustrates an example of an initial interface displayable in a browser of a salesperson communications device of the automated sales facilitation tool of FIG. 1, according to certain embodiments of the invention;

FIG. 10 illustrates an example of a referrals interface displayable in a browser of a salesperson communications device of the automated sales facilitation tool of FIG. 1, according to certain embodiments of the invention;

FIG. 11 illustrates an example of an account status interface displayable in a browser of a salesperson communications device of the automated sales facilitation tool of FIG. 1, according to certain embodiments of the invention;

FIG. 12 illustrates an example a finding referrals interface displayable in a browser of a salesperson communications device of the automated sales facilitation tool of FIG. 1, according to certain embodiments of the invention;

FIG. 13 illustrates a further example of the finding referrals interface of FIG. 12 displayable in a browser of a salesperson communications device of the automated sales facilitation tool of FIG. 1, according to certain embodiments of the invention;

FIG. 14 illustrates an example of a selecting referrals interface displayable in a browser of a salesperson communications device of the automated sales facilitation tool of FIG. 1, according to certain embodiments of the invention;

FIG. 15 illustrates an example of a requesting referrals interface displayable in a browser of a salesperson communications device of the automated sales facilitation tool of FIG. 1, according to certain embodiments of the invention;

FIG. 16 illustrates an example of a referral request results interface displayable in a browser of a salesperson communications device of the automated sales facilitation tool of FIG. 1, according to certain embodiments of the invention;

FIG. 17 illustrates an example of the account status interface of FIG. 11, upon entry and referral request as to a new account, displayable in a browser of a salesperson communications device of the automated sales facilitation tool of FIG. 1, according to certain embodiments of the invention;

FIG. 18 illustrates an example of a sales interface displayable in a browser of a salesperson communications device of the automated sales facilitation tool of FIG. 1, according to certain embodiments of the invention;

FIG. 19 illustrates an example of a sales approach interface displayable in a browser of a salesperson communications device of the automated sales facilitation tool of FIG. 1, according to certain embodiments of the invention;

FIG. 20 illustrates an example of a sales effort schedule interface displayable in a browser of a salesperson communications device of the automated sales facilitation tool of FIG. 1, according to certain embodiments of the invention;

FIG. 21 illustrates an example of a preliminary sales meeting plan interface displayable in a browser of a salesperson communications device of the automated sales facilitation tool of FIG. 1, according to certain embodiments of the invention;

FIG. 22 illustrates an example of a final sales plan interface displayable in a browser of a salesperson communications device of the automated sales facilitation tool of FIG. 1, according to certain embodiments of the invention;

FIG. 23 illustrates an example of the account status interface of FIGS. 11 and 17, upon entry and referral request as to the new account and development of strategy and showing strategy summary, displayable in a browser of a salesperson communications device of the automated sales facilitation tool of FIG. 1, according to certain embodiments of the invention;

FIG. 24 illustrates an example of a feedback interface displayable in a browser of a salesperson communications device of the automated sales facilitation tool of FIG. 1, according to certain embodiments of the invention;

FIG. 25 illustrates an example of an individual statistics recap interface displayable in a browser of a salesperson communications device of the automated sales facilitation tool of FIG. 1, according to certain embodiments of the invention;

FIG. 26 illustrates an example of a team credit interface displayable in a browser of a salesperson communications device of the automated sales facilitation tool of FIG. 1, according to certain embodiments of the invention;

FIG. 27 illustrates an example of a more detailed database schema of the automated sales facilitation tool of FIG. 1, similar to the simplified schema of FIG. 3 but as more commonly would be employed in actual practice in the embodiments, for relating sales- and customer-specific information, tracking salesperson contributions and efforts, and otherwise guiding sales processes, according to certain embodiments of the invention; and

FIG. 28 illustrates an example of data associations by the database according to the database schema of FIGS. 1 and 27, for a sales environment of use of the systems and methods herein, according to certain embodiments of the invention.

### DETAILED DESCRIPTION OF PREFERRED EMBODIMENTS

Automated Field Sales Process Facilitation Tool and Network

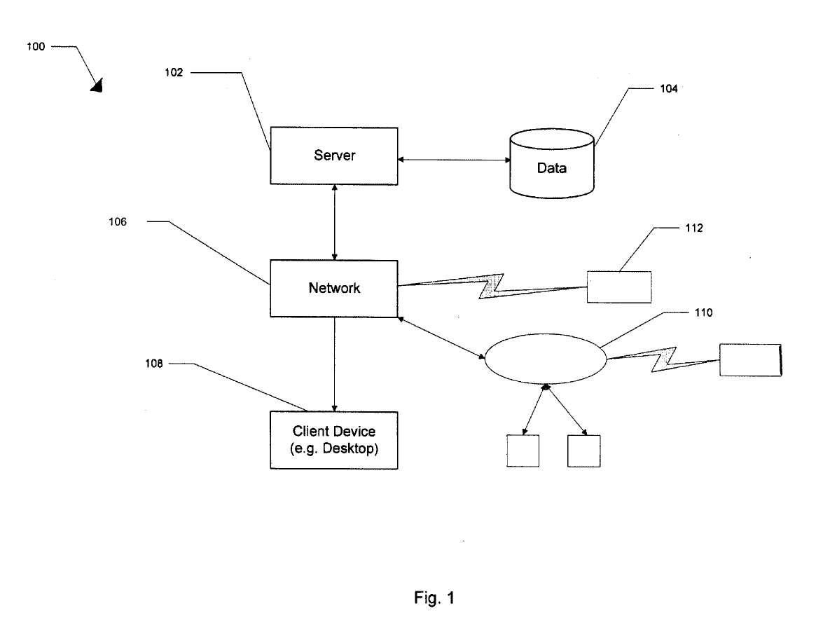

Referring to FIG. 1, a system 100 for selling, includes an automated sales process facilitation aid, i.e., sometimes referred to herein as a/the “sales tool”, for use by salespersons, company management and other permitted users. The sales tool of the system 100 aids the sales processes of salespersons and sales forces, including any cooperative groups of salespersons (whether or not within a company or otherwise aggregated or organized, as further described herein as to certain embodiments). In this respect, facilitation of sales processes via the sales tool includes not merely providing a database and search capability of conventional contact, scheduling and similar automated applications. Rather, the term “facilitation” as used herein in referring to the automated sales tool is all (or at least multiple) aspects of the entire sales function, including, for example: guiding and directing each particular sale effort and opportunity, making available quite relevant sale and customer specific information as to each respective sale opportunity and customer, evaluating credibility of sale and customer information and valuing/weighting for use in each particular successive sale opportunity instance, increasing participation and cooperation by salespersons in collection of best sales information, distributing and encouraging distribution of information to others within the sales force or other cooperative sales group, if and as applicable, objectively assessing salesperson and sales team efforts, promoting teamwork and morale, and incentivizing sales efforts, contributions and cooperation. Thus, without limiting the scope and various embodiments hereafter detailed, the sales tool of the system 100 is and should be considered a comprehensive, enterprise-wide aid to all sales functions and steps/processes involved of field sales efforts within companies, cooperative or subscribing sales groups, or other collectives of sales people and operations according the particular environment for the application.

The system 100, in effect, automates better/best sales practices within a sales force or group, such as of an enterprise, company, organization, cooperative, industry, subscriber pool, or other cooperative or team sales effort. The system 100 communicatively interconnects various computing and communications devices, for example, among other devices, a server 102, a database 104, and salesperson communication devices (e.g., a fixed device 108, a mobile device 112, and other networks and devices 110). The database 104 is particularly programmed to associate knowledge items of sales information and sales opportunity items, through relation of specific items of information of sales maintained in the database, and to encourage sharing of such items and information of sales through collaboration among users and reward of incentives in return for valuable input participation by users, as more fully herein described. The server 102 includes or otherwise connects to and accesses the database 104. The server 102 is, for example, one or more server computers including a microprocessor, memory storage, and communications capabilities via wire, wireless, optical, satellite, and/or other communicative connection with and over a network 106. The server 102 is communicatively connected to the processing and communication devices 114 of the network 106, such as, for example, the fixed device 108, the mobile device 112, and other communicative networks and devices 110.

The following description refers specifically, from time to time, to the terms “devices 114”, and/or the fixed “device 108”, the mobile “device 112”, and/or the other “networks and devices 110”, when discussing the embodiments. However, these terms are each generally employed herein interchangeably to mean and refer to any one or more of such devices or other communicative devices. In these regards, the description is intended to be construed and interpreted in broadest manner, to mean and include any and all types of communicative device employable in accordance with the embodiments whenever any such reference is used (unless specifically to the contrary stated or unless the context dictates otherwise—e.g., if specifically referencing a feature for mobile operations, etc.).

Via the network 106, the server 102 communicates with the communicative devices 114 of the network 106, in a client-server or other data communicative manner. The network 106 is, for example, a packetized data network, operating per network protocols such as Transport Control Protocol/Internet Protocol (TCP/IP) or other conventional or future communications schemes. The database 104, via association or connection with the server 102, operates to perform various input, storage, search, retrieval, viewing, logical processing, and the like, as directed by respective communicative devices 114. Additionally, various management/administrator devices (not shown in detail in FIG. 1), either connected to the network 106, the server 102, and/or the database 104, or incorporated therein, are employed by information technology (IT) managers of those devices and the network for installing, populating, managing, interfacing and otherwise maintaining and implementing the network 106 and connected devices and features.

Each of the devices 114, such as the device 108, includes an interface to the database 104 and for communications with and between the server 102. This interface of the database 104 is communicated or otherwise made available to the device 108, such as upon request therefor triggered by the user of the device 108, automatically via call-up by the device 108 or otherwise, for example, through domain name/address access with a network/Internet browser application, or otherwise. The interface is served via communication over the network 106 by the server 102 to the device 108, such as via browser displayed portal, or the device 108 is otherwise equipped or installed with the interface. Alternately, certain or all elements for interfacing are stored on the user device 108 and other elements are served by the server 102, or as is otherwise desired for the implementation (e.g., lite or minimal client application can provide limited interfacing when using a cell phone or other mobile device or the like, etc. as the device 108).

Through the interface at the device 108, the user of the device 108 is prompted or permitted (e.g., by input key, mouse click, or the like) to initiate various operations of the database 104, or other operations with respect to communications with the server 102 and other use of the system 100. The user of the device 108 can, for example, direct the device 108, and thus the server 102 and database 104, to operate to allow input of data, search stored data, retrieve stored data, process input and/or stored data, and otherwise perform various manipulations and operations with or by the database 104, its data and applications. In each event, the device 108 performs these operations through making communications over the network 106 with the server 102 and database 104, as applicable.

The database 104 is any database application, software and/or hardware, having features, operability, and programmability sufficient for the embodiments, for example, a software-implemented relational database application, such as mySQL, SQLserver or Oracle. The database 104 includes or communicatively accesses (such as included in the server 102 or other hardware/software features) sufficient memory and elements for input, storage, retention, maintenance, utilization, sorting, access, viewing, and update of customer, contacts, sales and other information and data regarding sales and practices for the salesperson user of the device 108 and system 100. The server 102 and the database 104 provide further and various data and database operations and procedures by the system 100 as hereinafter further detailed.

Further as to the network 106, the network 106 includes a packetized data communications link or links, such as the Internet, an intranet, a virtual private network (VPN), a local area network (LAN), a wide area network (WAN), or the like, and can include wired, wireless, optical or other communicative links and combinations of links. The server 102, including or associated with the database 104, and/or other elements, devices and systems such as the devices 114 (e.g., including the device 108, as exemplary), are communicatively connected to and via the network 106. The network 106 can be a TCP/IP network or other data communications network operable over the particular communicative links and combinations, including intermittent trunk lines, local links, and other connections, servers, switches, routers and communications devices and elements. The network 106 is communicatively connectable to other and pluralities of communicative devices and links, in addition to the devices 114 and links shown in FIG. 1, including, for example, such features as internal VPNs, LANs, WANs, other Ethernet configurations, dial-up, local wireless, cellular wireless data, satellite and any and all other networked communications devices now or hereafter developed or deployed.

Alternately or additionally, the network 106, itself, is a LAN, Intranet, VPN, or some dedicated, non-publicly accessible, restricted access, subscription, limited use, internal, and/or enterprise or other similar communications network. In such instance, the server 102, and the database 104, as applicable, is similarly designed and useable, albeit with restricted or otherwise limited use or service as desired for the particular embodiment. A company, or branch or office location of a company, for example, can implement the system 100 internally within the company, via the company's communications systems, devices and networks or otherwise through dedicated systems. Communications technologies and links, both present and future, including all various communications vehicles, infrastructures and combinations, are employable for the purposes herein and in the embodiments, and are included within the scope and description. In any event, the network 106 communicatively connects various ones of the devices 114 (e.g., the fixed device 108, the mobile device 112, the other networks and devices 110, and others), as well as possibly other typical network communication devices, including such as, for example, laptop computers, personal digital assistant, cellular data phones and devices, manager/management computers, IT professional/administrator communications devices, and others, mobile, immobile, virtual or otherwise.

As an example, a salesperson using one of the devices 114 (e.g., device 108) communicatively connects to the network 106 and accesses the database 104, via the server 102. The communicative access allows the salesperson, using the device 108, to input, maintain, view, update, and perform logical operations with and on relevant customer and sales related information. An IT professional, likewise, can access the server 102, database 104 and/or other network-connected devices and features through another of the devices 114 (or another type of device not shown in FIG. 1) of the network 106. The IT professional/systems administrator can control, maintain, and otherwise manage the network 106, including the server 102, database 104 and other elements, with the device so used. Further, company managers, staff and others can also be allowed to access, or otherwise have made available, various reports, states, use statistics, and features of the system 100, including customer-relevant information, devices 114 and use or other states/statistics/criteria, the server 102 and/or database 104 features and circumstances, and other aspects, via communicative connection of one of the devices 114 (or another type of device not shown in FIG. 1) to the network 106.

Communicated signals, as well as networked links, between the server 102, database 104, devices 114, and any other access-permitted elements of the network 106, are secured or securable. Communications can be encrypted, secure socket layers (SSL) implemented, firewalls and other barriers can be included, and other security means now or hereafter developed can be employed as desired. Alternately, only certain of the communicated signals are secured or securable, or there can be no security, depending on the desired applications and configuration. Locally, at the devices 114, for example, the device 108, secure socket layer (SSL) protocols or other security layer or level communications are employed. If an Intranet, VPN, LAN or other type of links are the network 102, localized security, including login/password requirements, firewalls, device identifications, dedicated features, encryption, and the like are includable.

Method of Sales with Tool and Network:

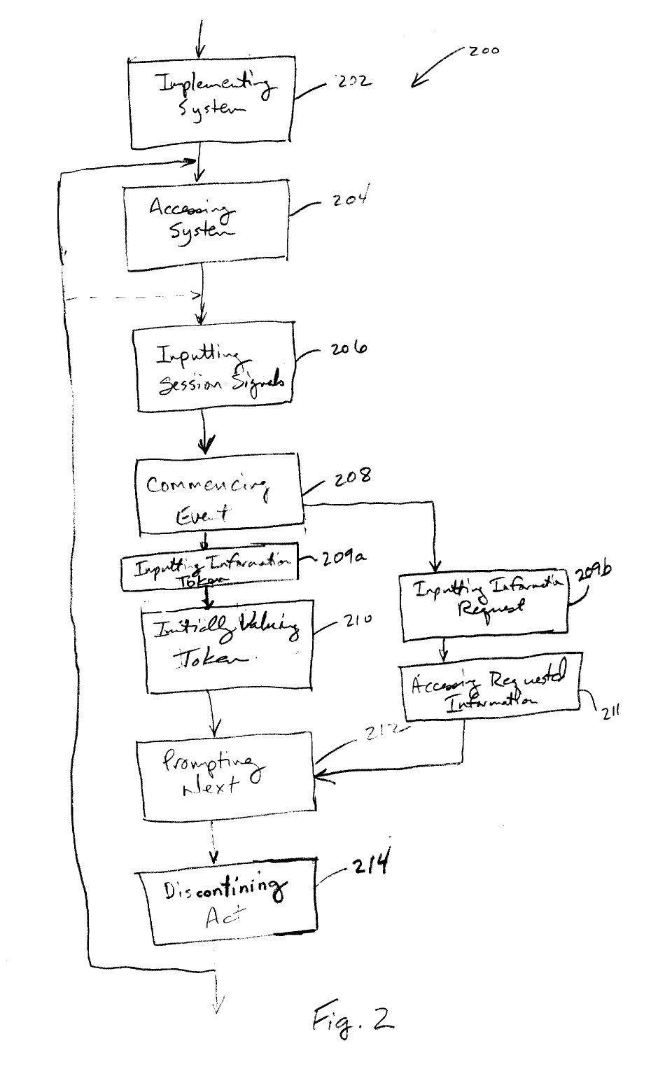

Referring to FIG. 2, a method 200 of the system 100 of FIG. 1 operates, via software, hardware and/or otherwise, as an automated sales tool or aid to salespersons. In operation, the system 100 is installed and accessed in the method 200. In such use, the method 200 provides steps and processes for driving and guiding sales and sales efforts, and supporting the salesperson through information and direction in sales. Particular and quite relevant customer, sale, marketing and other such information is made readily accessible by the system 100 and method 200 to the salesperson user of one of the devices 114 (or other access units or devices, as may be applicable). The method 200 and system 100 also provide other elements and features for salesperson users, such as sales data, processes, good practices, and incentives for use of the system 100 and method 200. The method 200 is particularly suitable for promoting use, contribution, cooperation and teamwork by salespersons, because of automated reward of incentives to salespersons according to the method 200.

The method 200 commences in a step 202 of implementing the system 100 (of FIG. 1). In the implementing step 202 of the method 200, software, hardware and other desired elements are configured centrally as the server 102 and the database 104 of FIG. 1, for communicative operations over the network 106. In the step 202, the database 104 is implemented, programmed and organized for sales tool operations, and programmed for communicative interactions over the network 106 through desired interfaces. Additionally in the step 202, the server 102 is configured and connected for communications on the network 106 and for operations of or in conjunction with the database 104 for purposes of communications over the network 106 associated with operations of the database 104.

A step 204 of accessing the system 100 by one of the devices 114, for example, the device 108, is then performed by the device 108. In the step 204, the device 108 is installed with and programmed and configured for communications over the network 106. In the step 204, an access-enablement application is implemented on the device 108, the device 108 is communicatively linked to the network 106, and communicative capabilities are established for the device 108. The step 204 can be performed at a location of the device 108 or, as applicable, remotely if such capability is provided.

The step 204 can further include, for example, permitting or granting permissions, authorization, device identification, access control list(s) creation and editing, and others, such as at or on the server 102 and/or the database 104, as desired or in accordance with implementation and configuration of the system 100. Alternately, the step 204 can be enabled via subscription through operations on the device 108, automation thereat, or through other elements, or other means as programmed. Upon completion of the step 204, the device 108 is useable by a salesperson, IT manager/administrator, company manager/staff, or other, as applicable and configured. The device 108 is operable via communications over the network 106 with the server 102 and database 104, therefore, the device 108 can be remotely located from the server 102 and database 104 or otherwise.

A step 206 of inputting includes communication of a sales tool session “start signal” by the device 108 to the server 102 and database 104 over the network 106. The start signal commences communications over the network 106, between the device 108 and the server 102 and database 104, for a usage session by the device 108. The inputting step 206, in effect, starts operations of the database 104 of the system 100 for sales tool operations of the server 102 and database 104, and of further communications back and forth between the device 108 and the server 102 and database 104 over the network 106 for such operations in a then-current usage session. The device 108 is, for example, used by a salesperson desiring sales tool operations from the salesperson's location where the device 108 is then situated. Alternately, according to configuration and desired implementation, the device 108 can be used for network 106 communications by an IT manager/administrator, a company manager, or other user of the device 108, the server 102, the database 104 or other aspects of the system 100.

Further in the step 206, the device 108 is employed by the salesperson (or other, as applicable) to input session control signals for commencing and directing the session substance, via communication by the device 108 over the network 106 to the server 102 and database 104. The step 206 directs the substance in the session of use of the sales tool of the system 100 by and at the device 108, by the salesperson user of the device 108. The session includes accessibility by the device 108 to the server 102 and database 104 and other operations of the system 100. For example, the step 206 includes log-in/password entry, designation of menu selection for type or use of the session, and similar directions at the device 108. Additionally, the step 206 includes signaling by the device 108 to the server 102 and database 104 to commence an operation of the sales tool, such as a sales information request session, a sales information input session, or the like.

The step 206 can be returned to and repeated at various times during the usage of the sales tool of the system 100. For example, return to menu selection or other directions input at the device 108 and communicated to the server 102 and database 104 control the sales tool operations of the database 104. The signals input by the device 108 switch functions or session operations, allow navigation through interfaces presented to the device 108 via communications from the server 104 and database 106, and otherwise enable and effect access to features, operations, interfaces, data and other aspects of the sales tool of the system 100. Although all possible instances for return to or repetition of the step 206 in the method 200 are not shown in detail in FIG. 2, certain embodiments and alternatives of the possibilities are mentioned herein throughout, and others will be apparent and understood to those skilled in the art, and all such possibilities are intended as included herein. In certain embodiments, a browser interface or the like interfaces the device 108 to the server 102 and database 104 for the step 204 and other steps of the method 200.

After the step of inputting 206, a step 208 of commencing a session event of the system 100 begins. The “event” is, for example, any initiation, registration, identification, information request, or other activity by the server 102 and database 104 of the system 100 acting as the sales tool, wherein the device 108 (and its user, via the device 108) to operate particular features or functions of the sales tool of the system 100. In the step 208, the device 108 inputs and communicates signals over the network 106 to the server 102 and database 106 which are either (1) an item of information that is of value or potential value contributing to the aggregate sales data/knowledge for the sales tool, or (2) an instruction/request signal to direct sales tool operations for accessing certain of the data/knowledge then-available from the sales tool. The sales data/knowledge of the sales tool is maintained in the database 104 for communicative access by the device 108 (and, in certain embodiments as later described, other such devices and users of the sales tool). In response to the input signals in the step 208, operations of the sales tool of the system 100 are commenced, corresponding to the substance of the particular signals.

In certain embodiments, the step 208, via communications between the database 104 and server 102 and the device 108, prompts for or requires the user of device 108 to input sales-related data or otherwise contribute to the sales tool operations of the server 102 and database 108. The sales-related data or other contribution by the salesperson for use of the device 108 in the commencing step 208 in the session, can, for example, be a requirement from the salesperson user and the device 108 in return for usage during the session of the sales tool provided by the system 100. In other embodiments, the salesperson user of the device 108 can be authorized and allowed to access information of sales knowledge of the sales tool, such as by subscription to the sales tool, authority per the arrangement and identity of the device 108 and user, Moreover, certain information of sales knowledge of the sales tool may be permitted for general access by the device 108 and all or certain other devices, whereas other information can be accessed only through permissions obtained by added payment therefor, in return for information of value input by the device 108, or other segregation and permission mechanisms, as applicable for the application.

If the device 108 seeks information that is then available to the device 108 (and the device is then enabled to obtain/access the information, either because of permission, subscription, etc., as applicable), the method 200 proceeds to a step 209b of inputting the request for information by the device 108. In the step 209b, the user of the device 108 causes the device 108 to direct request signals over the network 106 to the server 102 and database 104. The request signals can include a wide variety of possibilities, for example, the signals may indicate a request for retrieving and accessing information then-available from the system 100 that is of relevance to a current sale opportunity or the like. Other requests by the device 108 can include such matters as company, person, or other more specific data or information that may then be maintained in the database 104.

The step 209b commences operations of the database 104 of the sales tool in a step 211, to access, parse, sort, and retrieve applicable information, if any, relevant to the subject of the request of the step 209b. In the step 211, the database 104 obtains any applicable information therein, and the database 104 and server 102 communicate the information over the network 106 to the device 108. The information, or portions thereof as applicable, if received by the device 108, is accessed and viewable at the device 108. After the steps 209b and 211, the database 104 and server 102 operate to communicate to the device 108 a prompting signal 212 for a next communication or function.

In other instances of certain embodiments in operations of the sales tool of the system 100 per the method 200, the step 208 is followed by a step 209a of inputting an information token at the device 108. In the step 208, the salesperson using the device 108 for the session inputs an item of information or otherwise contributes or cooperates in sales driven conduct via the device 108, such as by inputting certain facts of a new sales opportunity, relevant contacts for the opportunity, or other aspects that can further sales efforts of the salesman and others, using the system 100 with the devices 114 (as selectively desired and configured, the information can be made available to others or not, according to the implementation, as later further explained). For purposes herein, the particular item of information or other input by the salesperson via the device 108 is referred to as a “token”. The “token” is, for example, any information, trigger, flag, data, keystroke, mouse click, log-in, or other input signal by the device 108, initiated by the salesperson or other user of the device 108, that is communicated to the server 102 and database 104 of the sales tool and that is recognized by the database 104 as capable of sales process facilitation via the system 100. Any of a wide variety of inputs and actions input to the device 108 could be the token in any particular application. The token is, in any event, something that corresponds or is an information that contributes sale knowledge to the system 100 for the salesperson and its other users. The token is stored or acted on by the database 104 in manners contributing to the aggregate knowledge and value of such knowledge that the sales tool holds and uses. Certain details of possible tokens in certain embodiments are detailed later.

A significant aspect of the system 100 and method 200 is that salesperson users of devices 114, like the device 108, are encouraged to input valuable information or knowledge to the system 100, for the benefit of the salesperson and others. For example, the salesperson user of the device 108, discussed above, can be permitted no access or limited access to features, resources, information, and so forth of the sales tool of the system 100, unless and until the salesperson via the device 108 enters tokens that are valuable to the system 100 as a whole. The tokens contributed by the salesperson via the device 108 are furthermore rated or valued by the system 100 (e.g., by feedback of other users input to the system 100, weighted computations based on such feedback and system 100 operational policies, and other variables and processes of the system 100) in order to provide these and further advantage to the salesman in using the sales tool of the system 100. That the salesperson using the device 108 must enter the token in order to gain access, additional access or usage, or similar incentive or value available by increased access or permission to the system 100 or some benefit of the sales tool session, is significant to certain aspects of the embodiments, as this promotes contributions of value by each salesperson and also promotes sales efforts among all salesperson users of the sales tool by increasing relevance, credibility and value of the tool and information/knowledge thereof.

In certain embodiments, for example, the salesperson using the system 100 can be permitted limited access to resources of and available via the system, unless or until the salesperson enters tokens, performs certain features of the system 100 or undertakes other valued effort. In the case of entry of tokens by salespersons, tokens (i.e., being sales-relevant information) are ratable through feedback of other salespersons using the system 100 by feedback input to the system 100 by the other salespersons. As a salesperson continues to enter tokens that are perceived as valuable by other salespersons (or those accessing the system 100, such as managers or the like), feedback is tracked and registered by the system 100 and attributed to the salesperson providing the tokens. Tokens that provide greater contribution towards revenue are evaluated by the system 100 processing (e.g., via feedback and company policies or the like), and the system 100 elevates status/permission for the contributor in the system 100 and its use by the contributor. Of course, wide variation is possible in value attribution, weighting, feedback options, system variables and policies, and the like, and these will be apparent from the entirety hereof. All such variations are included herein.

Although not shown in detail in FIG. 2, but as will be later described as to certain more specific embodiments of certain applications of the system 100 and method 200, tokens input by devices 114 for contributions of information or other items to the sales tool of the system 100 are each evaluated and rated via the system 100 and method 200. In certain embodiments, the tokens are scrutinized via the system 100 and method 200 for value to sales process facilitation. The system 100 and method 200 track tokens of each contributing salesperson using the devices 114, and attribute incentive or advantage to the salesperson user for particular tokens of value so contributed. The value of tokens is measured by the system 100 and method 200 in a variety of manners and possibilities. For example, extent of usage or access to particular tokens is tracked as an indicator of value thereof, salesperson users of the sales tool provide feedback indicative of token value, sales result and revenue attributable to the token is a component of the value attributed, and other similar and various value indicators or measures are attributable for respective tokens, as desired and implemented for the particular configuration and application. The system 100 and method 200, in each event, track and maintain records of value and attribute/correspond value to the contributor user, thereby encouraging participation and contribution to the sales process facilitation provided by the sales tool.

Moreover, in certain embodiments, tokens input by the device 108 are validated or assessed for credibility, policy compliance and the like, either via the system 100 and method 200 or by other activities. For example, an implementation of the sales tool for a particular company, industry, group of users, or the like, can require compliance of tokens with certain policies or procedures therefor. An authorized person of a company (or other within a particular environment of the application) can be notified of token submission by the device 108, and conducts review of the token and subject to approve or reject the token or an aspect of it. In operation, the token is not maintained for or by the sales tool unless and until approved. Further variations are possible in these respects, such as tokens may be subjected to review for originality, proper attribution of credit to the original contributor, and so forth. The person reviewing the token can determine credit for value with respect to the token or proceed through other avenues. In other instances, reviews of this sort, and a wide host of other possibilities, can be automated or otherwise implemented via or for the sales tool, and all such possibilities and options are included herein.

Thus, depending on desired application of the database 104 and devices 114 of the system in promoting and facilitating sales efforts and the sales process, the token can, for a wide variety of the possible implementations of the system 100 and method 200, be any action, input, or other effort to and for the contribution to sales that is capable of detection as something of contribution or cooperation. Further advantage is obtained through this concept of tokens and value therefor in the system 100 and method 200 of the sales tool, for example, the token input by the user of the device 108 can be rewarded, for example, by value assessment via the system and method 200, as an element of compensation to the user who so inputs the token or other reward or incentive to the contributing user. The reward aspect can be performed via the system 100 and method 200, such as per the configuration, implementation and programming, for example, in permitting the salesperson contributor to further utilize aspects of the database 104 to obtain added features or the like. Moreover, any of a wide variety of other possible rewards, such as monetary compensation, can be apportioned, either via the particular implementation for the system 100 and methods 200 or from managerial decision based on reports and data therefrom, as may be appropriate and desired for the application of the system 100 and method 200. The particular token that is required from the device 108 in use of the system 100 and method 200 as the sales tool can, thus, be automated, logically determined (e.g., artificial intelligence, company management dictated), pre-programmed, or otherwise dictated as the needs exist to further the sales efforts. As will be apparent, the particular design, configuration and implementation of the system 100 and method 200 for the sales tool in any particular environment or application, can promote and facilitate sales efforts and processes, in accordance with desired effect.

In certain embodiments, a company or group using the system 100 and method 200 can choose to validate a token entered by a salesperson, such as to ensure compliance of the token with policies and procedures of the company or group. In such instance, a responsible person is notified of token submission, conducts review or filtering of the token information, and decides via the system 100 and method 200 to accept/approve or reject/disapprove the submitted token. The token does not then become available through the system 100 and method 200 to other users unless or until an authority, such as a sales supervisor, company manager or the like, approves the token. Via the system 100 and method 200, or as an add-on or extension to thereto or by extraneous process/action thereto, the authority can determine during the review that the token is not originated by the salesperson (for example, another may already have entered the token, another may claim the token, or otherwise), such as if a copy or slight variation of a previously submitted token. The authority then can decide how to treat the token and its inclusion or other effect in the system 100 and method 200, for example, the authority can reject the token, attribute proper credit for the token to submitters or others, attribute shared credit for the token, or handle in any of a wide variety of ways as applicable and according to system 100 and method 200 configuration and implementation.

Continuing to refer to FIG. 2 and the method 200, a step 210 of initially valuing automatically occurs via the database 104 of the system 100, upon due completion of the steps 206, 208, and 209a. For example, a “credit”, indicative of value, is registered or associated to the token and/or event of the steps 208 and 209a. This credit from the step 210 is a type of incentive that is related to or associated with the device 108 and/or the particular salesperson then using the device 108. The value or weight of any particular credit is accorded by the database 104, based on any of a wide variety of factors related to sales promotion and cooperation, teamwork, utility and other sales-relevance and sales-value benefiting concepts. For example, pre-programmed functionality/logic for the database 104, company management dictate, feedback from other users of the sales tool as to value, extent of usage of by others, or other algorithms can determine the particular credit afforded in return for each token of sales-value/sales-benefit contributed by the device 108 (and its salesperson user) in use of the sales tool of the system 100. The value or weight for any particular credit can be based on any of a wide variety of facts of relevance to the environment, intentions and use for the sales tool of the system 100 in the application in which employed. Tokens of particular relevance to a sale, customer, contact, or other various information or result, for example, can be afforded different credit in return for the token in view of the value/benefit to sales efforts.

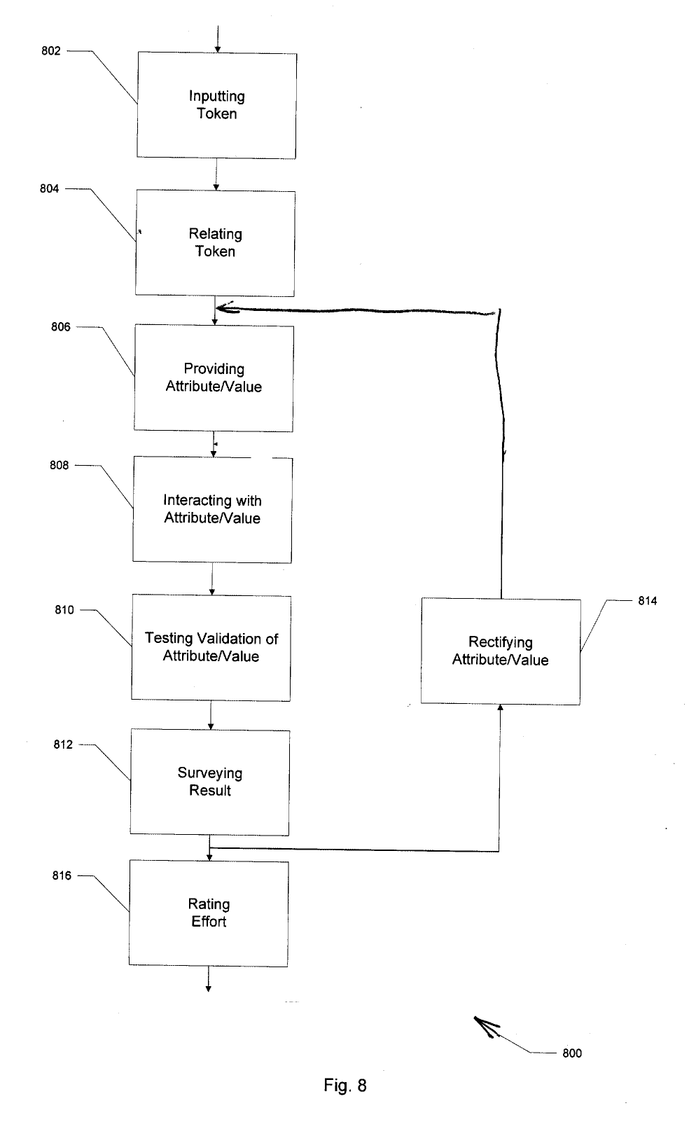

Based on the credit corresponding to each instance of token (and/or event), the database 104 (or other sources, including aspects of the system 100, company management, either subjectively, objectively, or combinations, or otherwise) can assign tangible value or benefit to varieties of the credited act or information, the cumulated or aggregated credits, particularly desirable credit reasons or bases for the credit, or other variations and possibilities, all in order to promote sales efforts and practices through cooperation, widest salesperson participation, benefits gained by the company or enterprise, and/or others. Certain tangible value or benefit of relevance and corresponding to credit(s) may be, for example, a particularly relevant information or use of the database 104 in the token provider's interest, customer insights, contacts choices and information, salesperson compensation impacts, and/or other various information or result. As later further detailed as to certain embodiments of the system 100 and method 200, the server 102 and database 104 of the system 100 perform the initial valuing step 210 (in conjunction with the device 108 and/or the salesperson user, or as otherwise dictated) in accordance with programmed and set protocols. Further valuing (not shown in FIG. 2, but hereafter described including with respect to FIG. 8) of tokens is thereafter automatedly performed by the system 100 and method 200, or otherwise performed, including as a result of feedback of users of the sales tool, successful sale results, extent of usage of tokens or relevance to other users, or as implemented through any of a wide variety and array of applicable schemes for the application, function and use, in order to promote, guide, and facilitate best sales practices and processes and capitalize on desired sales opportunities.

Upon occurrence of the step 210, a step of prompting 212 is (often) thereafter communicated over the network 106 (or otherwise made known) to the device 108. The step of prompting 212, as with other steps of the method 200, includes any of a wide variation of acts and effects at the device 108. For example, the step 212 can include such acts/effects as instructing/guiding the salesperson via the device 108 in the session, sale or other sales effort; apprising the salesperson of particularly relevant information to sales, including possibly any then-current opportunity of interest to the salesman; automatically initiating an operation of the device 108, such as a further request to the device 108 (and salesperson) for additional related token input, for correction or clarification, for further instruction by the device 108 in the session, for logging-out or other manifestation by or of the device 108, and any of a wide variety of other possibilities. A number of these wide variety of possibilities and details of the step 212 are later detailed in describing certain embodiments.

Finally in the method 200, either automatically as or after the step 212, or through other communicated signals by or to the device 108 or otherwise, the use via the device 108 of the database 104 and sales tool of the system 100 for the session, is discontinued in a step 214. The step 214 of discontinuing can include merely terminating a present session of use of the sales tool by the device (such as discontinuing the present database 104 activities or usage), interrupting communications by the device 108 over the network 106 with the server 102 and database 104, continuing such communications or session substance in a different mode or usage, or otherwise ending for the device 108 the presently then-occurring session, activity of the database 104, or other sales tool operation of the system 100. A wide variety of possibilities and options can be provided, allowed, triggered, or otherwise performed through the step 214, and at least certain of these are later detailed in describing various embodiments.

After the step 214, a next use of the sales tool of the system 100 can again be commenced by return to the step 204 and continuing successive steps of the method 200. Alternately, in certain configurations in which the accessing step 204 is continued (for example, per a different mode or usage by and at the device 108 or otherwise), the method 200 instead returns to the step 206 and proceeds accordingly (e.g., the phantom arrow in FIG. 2 exemplifies such operation of the method 200). The method 200, in such manner, and with wide variation of intermittent, additional, alternative, and applicable steps, provides relevant sale- and customer-specific information accessible to salespersons, increases participation and cooperation by salespersons in sharing, contribution, collection and distribution of such information, furthers uniformity and better practices in sales efforts throughout the sales force, and otherwise promotes and benefits sales activities in the environment employed.

Veracity, Credibility and Value Attribution Feedback Mechanisms:

As has been mentioned, the system 100 and method 200 encourage participation and valuable contribution of information and the like (i.e., tokens), by salespersons and other users of the sales tool of the system 100. The credits for contributions, system usage, sales participation efforts, and the like that are registered and accounted for by the system 100 and its method 200, and related thereby to the contributing salesperson user, provide the incentives. Various feedback mechanisms of the system 100 and method 200 ensure veracity and credibility of information of the sales tool of the system 100 and method 200, and also allow for value attribution and credits for contributors and the like.

In particular, feedback mechanisms include checks and balances at various of the steps and stages of the method 200, such as whenever information is input by users of devices 114 for sales process facilitation. These checks and balances include, for example, notifications to reviewers for determining characteristics, originality, and policy/procedure compliance whenever tokens are input; requests for and input of assessment and feedback to those accessing and using information of the sales tool as to sales opportunity value of tokens, other users and information sources, and the like; feedback ratings compiled for each salesperson user based on token contributions, sales efforts and participation, and responses to other users on requests for contacts or action and others; and automated operations of the system 100 and method 200 that confirm, correct, and detect and question inputs, use, and other aspects during and from salesperson use. Other feedback and checks and balances can also be included according to desired design, implementation, and configuration of the sales tool of the system 100.

Particular feedback mechanism that have sales relevancy and significance include the system 100 and method 200 features and operations of requesting referrals/contacts and surveys each via the system 100 and method 200. Aspects of these features and operations, and the relevance and significance are later discussed as to certain embodiments. In general, the requesting referrals/contacts operations of the system 100 and method 200 ensure best available contact sources and information to users, and also enable accounting for value contributions upon participation by the users. The survey operations of the system 100 and method 200 additionally promote accuracy, credibility and best practices features through requests for and feedback from users as to particulars of use, and also further support the value accounting for contributions among users. Embodiments herein further detail certain of the features, operations and benefits of the various feedback mechanisms, and address the wide variety of possibilities therefor in order to facilitate the sales process through use of the system 100 and method 200.

Automated Sales Process Facilitation Tool Data and Database:

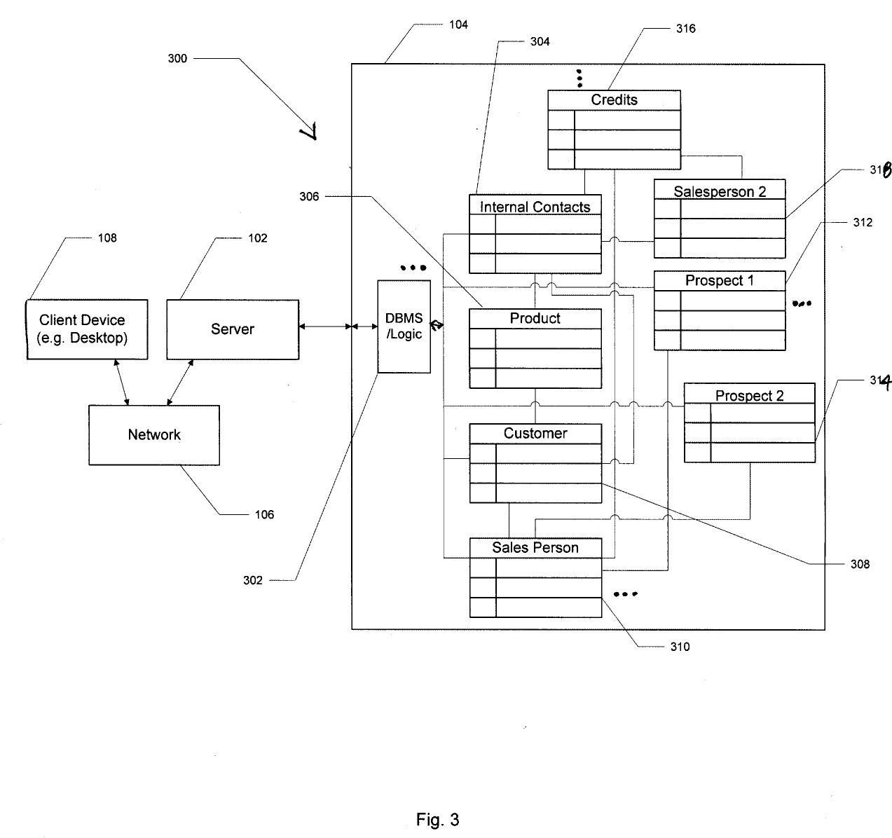

Referring to FIG. 3, in conjunction with FIG. 1, a database 104 of the system 100 has a relational architecture and schema 300. As previously described in connection with FIG. 1, the database 104 communicatively connects to the server 102. The server 102 and the device 108 (along with all other devices 114) communicatively connect via the network 106. The database 104 associates sales related data and information in a manner in which knowledge items (e.g., information, such as competitive strengths and weaknesses captured from prior sales experiences and other sales-related information) are associated with opportunity items (e.g., potential customers, sales, efforts and sales possibility information). Thus, specific items of information—or attributes—associated with the opportunity items (e.g., company, product, industry, geography, outcomes, and others) can be used by the system to determine the relevance of knowledge items to future opportunity items. These knowledge items are thus made more valuable in the sales effort to enable the system to make relevant or meaningful recommendations of knowledge items for subsequent opportunities based on the attributes of those opportunities. Users of the system 100, method 200 and database 104 thereof, are incentivized thereby to contribute valuable sales information, for use and with collaboration by other users and collaboration and ranking/valuing of information contributions. User-contributors of valuable sale information are rewarded/incentivized by the system 100 and method 200, and rewards/incentives are afforded to such contributors and stored, related and accessed through database 104 operations. The operations of the database 104 in the system 100 and method 200 promote sharing and cooperative/collaborative use and input of relevant and valuable information for sales, as further herein described.

Referring to FIG. 3, the relational architecture and schema 300 of the database 104 in FIG. 3 is an example to aid in understanding of the embodiments. Those skilled in the art will know and understand that there are numerous and widely varied options, alternatives, substitutions, changes, additions, deletions and other modifications and possibilities in any and each respective application for the database 104 in the system 100. In the example of FIG. 3, the architecture and schema 300 includes a database manager 302, having various processing, logic, parsing, storage, relationships, indexing, look-up, and other operations of the database 104 or operative for or on data of the database 104.

The architecture and schema 300 includes one or more tables, as is typical. The tables are interrelated as parent-child in hierarchies and other aspects, as is also typical, and the database manager 302 links/relates data from the tables according to design. Each table includes one or more records. The records each include one or more fields. The fields contain items (i.e., pieces of information/data corresponding to the field). The database manager 302 enables queries, other sorting and filtering, logic and parse operations, calculations, and reporting (as well as other actions) on and with the data/items, fields, records, and tables of the database 104. The database manager 302 operates according to desired programming configuration therefor, and as instructed to operate by input signals of an interface (not shown in detail). The interface of the database 104 is communicatively connected to the server 102, and thus the network 106 and the device 108 (and all others of the devices 114).

Continuing to refer to FIG. 3, the tables (“entities”) of the database 104 include, for example, an internal contacts table 304, a products table 306, a customers table 308, a salesperson table 310, a prospects “1” table 312, a prospects “2” table 314, a credits table 316, and a salesperson “1” table 318. Certain possible interrelatedness of the tables (“entities”) is variously indicated in FIG. 3 by the lines (“relationships”) between tables (“entities”), records of tables, fields of records (“columns”), and items contained in the fields (“rows”), however, this interrelatedness is intended only as exemplary. In any particular embodiment, the database 104 can include a wide variety of the architecture 300, including other and different tables, records, fields and items, and interrelatedness thereof. Alternatively or additionally, the elements in the database may be represented through a flat file database structure, a hierarchical database structure, and object database structure, or combination or others. Significant tables of the database 104 for particular ones of the embodiments herein later described in examples, include at least the internal contacts table 304, the products table 306, the credits table 316, and the salesperson table 310 (or salesperson “1” table 318 and similar tables for all salespersons utilizing the system 100).

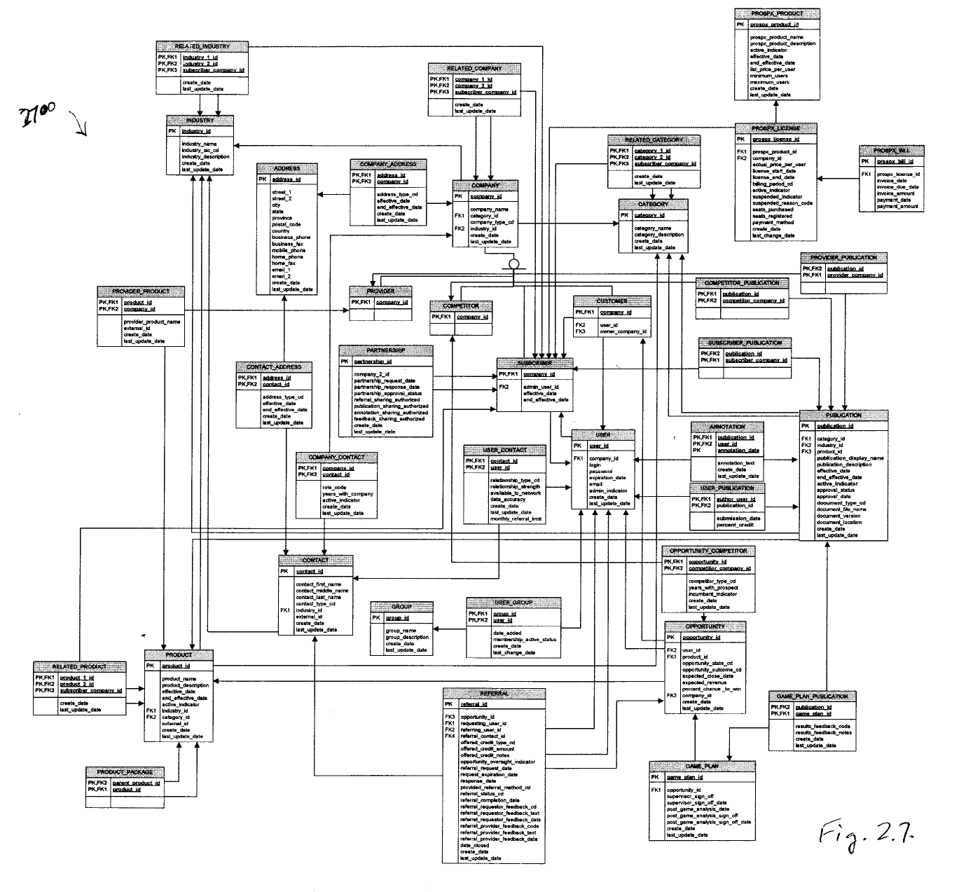

Referring to FIG. 27, a more detailed database schema 2200 of the database 104 of the system 100 is exemplary of database configuration in practice in certain embodiments. Specific entities, relationships, columns and rows of the schema 2200 are shown, but not described here in detail. A wide variety of possibilities for the schema employed in practice will depend upon numerous factors and considerations, particularly as to what data and information of the database is most sale- and customer-relevant as to the environment in which the sales tool of the system 100 and method 200 is employed. Additionally, relational character of the various entities, relationships, columns and rows of the schema 2200 can be varied or otherwise addressed in order to promote best/better sales practices, guidance, processes and other sales process facilitation through use of the system 100 and method 200.

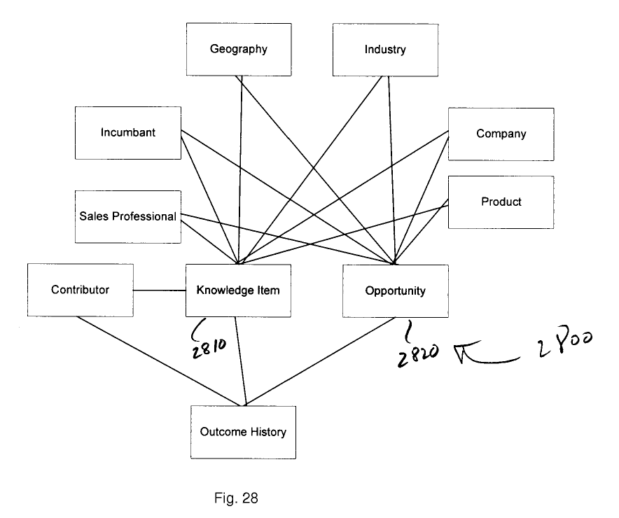

Referring to FIG. 28, an example of data and information associations via the database 104 is based on knowledge items 2810 and opportunity items 2820. The opportunity items 2820 are data of potential customers and continuing customers and related possibilities for additional and further sales efforts and closings. These opportunity items 2820 are input by the salesperson users of the system 100 and method 200, and are maintained by the database 104 thereof. For example, an opportunity for a new potential customer is identified by the salesperson user by input to the system 100 and method 200. The opportunity identifier is saved by the database 104 and related to various information of the database 104 as to the particular opportunity, including prior data that may be contained in the database 104 and newly input information to the database 104 by the salesperson user or other later accessors. The opportunity items 2820 include, for example, company names, geographical location, applicable industry, potential products, the salesperson providing input, others who have similarly identified or been associated with the company or who have provided relevant valuable information, other sales efforts/results/outcomes, and others. The knowledge items 2810 are data that have specific relevance and value to the opportunity items 2820. These knowledge items 2810 are associated to the opportunity items 2820 automatically by the database 104 and its operations at the time the knowledge items are selected by sales persons for use on opportunities. The knowledge items 2810 are prior and newly input information, such as for example, salespersons having contacts or relations with the opportunity, geography, products, industry or the like of the opportunity, and accessors who do or have in the past input relevant valuable information and the like. For example, the database 104 is particularly programmed to associate the knowledge items 2810 of sales information and opportunity items 2820 of sales possibilities, through relation of specific items of information of sales maintained in the database, so that a user of the system 100 and method 200 can obtain valuable relevant specific knowledge items 2810 as to each respective one of the opportunity items 2820. As a condition to obtaining at least certain of the knowledge items 2810 for any respective opportunity items 2820, the user of the system 100 and method 200 is encouraged and required to input and share additional valuable relevant information of the knowledge items 2810, opportunity items 2810 for the benefit and availability of all users. In return for contributions by the user of the system 100 and method 200 of inputting and making available additional and best relevant valuable knowledge items 2810 for each opportunity item 2820, the user is rewarded with incentives by the system 100 and method 200, such as further access to database 104 information, ranking among peers, and recognition within the enterprise of the system 100 and method 200

Those skilled in the art will know and appreciate various programming and configuration possibilities and options for database organization and architecture, as well as applicable knowledge items 2810, opportunity items 2820, and contribution, participation, incentivization, and collaboration possibilities; however, the particular database 104 and schema 300, and knowledge and opportunity items 2810, 2820, operable for the embodiments herein are unique and distinct in order to operate in the embodiments, as hereinbefore and as hereafter further detailed. Moreover, those skilled in the art will know and appreciate the wide variation possible in related, valuable, and relevant information, and relational, associational and incentive possibilities therefor, in keeping with the foregoing.

Automated Sales Process Facilitation Tool Database and Population

Implementation:

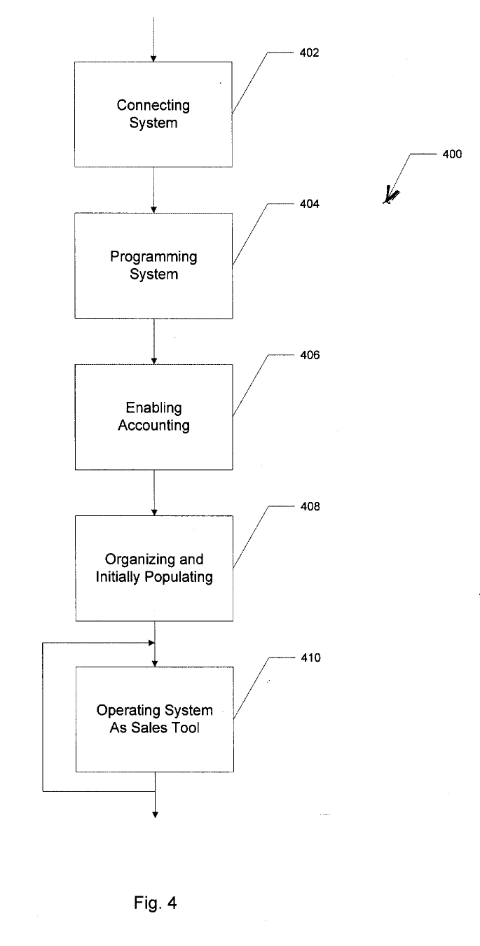

Referring to FIG. 4, in conjunction with FIGS. 1 and 2, a method 400 is performed in the implementing step 202 of the method 200 of FIG. 2. The method includes a step 402 of communicative connecting/interconnecting of the system 100, including providing communicative facilities and equipment for the devices 114 and the server 102, physically or otherwise connecting links to the network and the various devices 114 and server 102 as well as intermittent links and channels, effecting protocol operations via programming and communications elements, and otherwise, all so that the devices 114 can each communicate with the server 102 and database 104 over the network 106 and, in certain embodiments as desired, communicate with and among the others.

In a step 404, configuring (i.e., set-up, implementation, and installation of system, network, operations and devices) of settings, variables, options, features and the like as may be configurable in the system 100, and particularly as to the sales tool operations of the system 100, per the application and environment of the system 100, is performed. The step includes, for example, programming the database 104 and software of the server 102 for operation as the sales tool (with functionalities and features as herein detailed), segregating and organizing user-accounts and other relationships, establishing user-access and security mechanisms, interfacing or programming interfacing for communications between devices 114 and the server 102 and database 104 and otherwise. Additionally, the step 404 can include providing, loading or installing client and communications software and functions to the devices 114, and various other aspects required for network 102 communications and database 104 operations via such communications.

Several scenarios are possible for the configuring step 404, as to where and how the system 100 is implemented and operated for sales tool functions. For example, a company can host the sales tool functions, such as by hosting the database 104 and its operations at a central facility or the like. In such an arrangement, the system 100 can have uniform operation as to all permitted users, for example, users can be subscribers, a trade group, a sales force, or the like, and sales process facilitation information and features of the system 100 via the database 104 can be available to those subscribers or other users. The hosting company in such an arrangement can profit from host activities in a variety of ways, including such as fees payable by users or groups of users for access, advertisement revenue from third party advertisers allowed to display information or the like to users, information value as obtained from users or as made available to users, and a wide variety of other possibilities and business concepts. Such a hosting company can also, or alternatively, segregate users, accounts, information, access, options and the like and price or otherwise obtain fees or other value according to use or benefits of these possibilities. Another implementation of the system 100 can be internal within a company, industry, trade group, or other organization. In such an instance, the organization can host or have hosted the system 100, including database 104, server 102 and the like. Security possibilities and customization for the internally maintained implementation is widely varied, and all variations are included herein. Implementation, licensing, and consulting can support the internal implementation in certain embodiments. Another particular implementation for the system 100 is hosted by a product supplier, such as an insurance carrier that offers insurance policies and the like that is interested in making the system 100 available to brokers who offer the carrier insurance products. In this type of implementation of the system 100, the hosting supplier can permit access to the sales tool of the system 100 for furthering sales by the supplier, including by offering products in conjunction with the system 100 features, as promotional value of the service, for learning broker and sales related information, and other reasons. As can be seen and understood, the system 100 is configurable for a wide array and variation of uses and scenarios, and all that are possible in accordance with the concepts and intentions are included herein.

An enabling step 406 is performed for the various devices 114 for salesperson use. In the step 406, the devices 114 are configured for applicable access and use of the system 100. The step 406 includes such procedures as, for example, setting addresses and communications options of the devices 114, initializing availability of access via network 106 communications with the server 102 and database 104, and otherwise setting-up each of the devices 114 for salesperson use in the system 100 for sales tool operations. Similarly, any administrator, management/staff, and other users of devices are configured to, as applicable, access, maintain, obtain data and information of use and other devices, and otherwise administer and supervise uses of the system 100 by salespersons.

In a step 408 of organizing and initially populating the database 104, the database 104 is accessed, for example, by an administrator or other IT personnel to initialize the database 104 for use for the system 100 as the sales tool. Further details of the step 408 are later described.

Continued operating in a step 410 of the system 100 as the sales tool, by a salesperson using one of the devices 114 of the system 100, such as the device 108, is possible after completion of the foregoing steps as to the device 108. The operating step 410 proceeds generally in accord with the steps 204-214 of the method 200 of FIG. 2, and as further detailed hereafter as to various aspects and features.

Those skilled in the art will know and appreciate that there are and will be various options, alternatives and possibilities for performance and completion of at least certain of the steps of the method 400 (e.g., the connecting step 402 and the enabling access step 406), and all are included in the embodiments. Moreover, those skilled in the art will know and appreciate that the method 400, or steps and portions thereof (e.g., including the enabling access step 406), must be performed and completed for each of the devices 114 in the system 100 (i.e., and reversed for any discontinued devices 114, etc.), and that general maintenance, update, and oversight are implementable as to the various steps of the method 400, including other and further steps for operations.

Initial Population of Database:

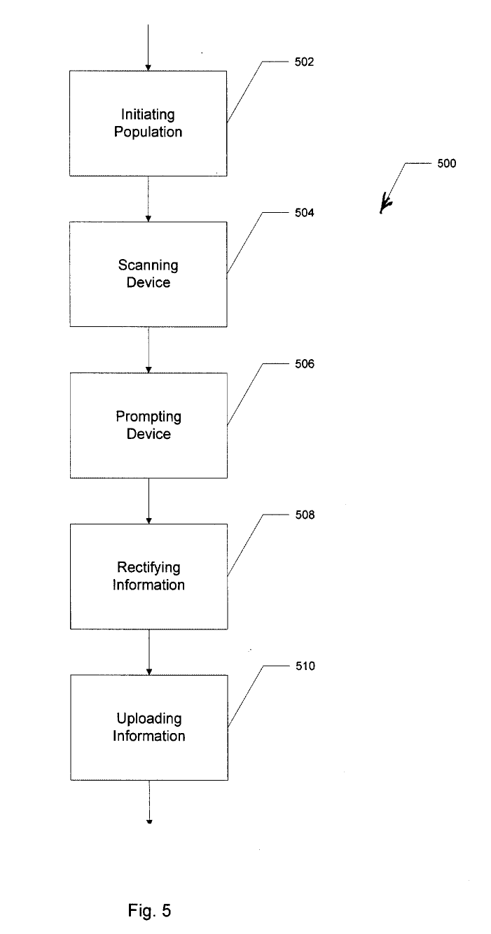

Referring to FIG. 5, in the initial accessing step 204 of the method 200, and more specifically, as included in the organizing and initially populating step 408 of the method 400 of FIG. 4 thereof, an initial populating of the database 104 of the sales tool of the system 100 occurs through a method 500. Initially, after communicative connection and set-up of one of the devices 114, for example, the device 108, the salesperson device 108, for example, a salesperson's computer as one of the devices 114, communicates with the server 102 over the network 106 in the method 500 of initially populating the database 106 with relevant sales information of the device 108 and its user. The method 500 commences in an initiating populate step 502, via login/password or other initiating protocols, for system 100 operations through network 106 communications. Thereafter, a scanning step 504 automatedly or via input on the device 108 scans/searches the device 108 for relevant customer information for the database 104. The scanning step 504 includes search and parsing of address/contact and e-mail applications and files, as well as other sales information, data, and sources, for example, conventional CRM systems and the like, e-mail and contacts management applications like Microsoft Outlook, Eudora, Thunderbird, Lotus Notes, provider and enterprise application services such as salesforce.com, ACT, Seibel, and others.

In a prompting step 506, the device 108, in communications with the server 102 and database 104, prompts the salesperson or other user to complete missing information as logically determined from the scanning step 504 results. For example, templates and forms can be supplied to and displayed at the device 108 through network 106 communications with the server 102 and database 104 or otherwise logically dictated at the user-device 108 (such as through client software application or the like). Information from the scanning step 504 or supplied in the prompting step 506 can include, for example, customer company identity, contacts, referral sources, departments, personnel titles, and a wide assortment of other data and information that is sales relevant or significant. Additionally, the device 108 allows the salesperson user to input other or further data or otherwise contribute information for the database 104 and operations, as may be desired in the application. Other salesperson inputs via the device 108 in these regards can include data qualifiers, categorizers, and corrections of data already populated in the database 104, from the scanning step 504 or otherwise. Examples of qualifiers that could be so input by the salesperson via the device 108 in certain embodiments include indicators of the salesperson's strength of relationship with a contact, a number of introductions the salesperson believes are possible into the contact within a selected duration of time, anticipated accuracy of information regarding the contact, and others.

In a rectifying step 508, the system 100, via programmed logic, identifies and resolves misspelling, inaccuracies, information and content errors and the like. The step 508 includes automated response(s), correction or fix, and alternately or additionally includes further prompting, printed check, and manual or other initiated resolution at the device 108 or, as applicable, at another aspect of the system 100. A graphical or other user device 108 interface, together with keypad, keyboard, mouse or other input, allows the user of the device 108 to interact at the device 108 in the database populating via the method 500.

Once all customer relevant information of the user-device 108 is ready for the database 104, the device 108 uploads the information over the network 106 to the server 102 and database 104 in an uploading step 510. Alternate means for uploading or delivering the information to the server 102 and database 104 are included in the system 100. The alternate means include, for example, disk or other readable storage device delivered to the server 102 or database 104, upload by other or associated device of the network 106, computer readable analog-type information such as via scanning and optical character reading or other, e-mail communication, peer-to-peer transfer, and other options.

Alternately, the uploading step 510 can occur prior to the rectifying step 508, in certain embodiments if desired. For example, the database 104 or other logic/processor communicatively connected to the database 104 and server 102 provides the rectifying in the step 508. Further, the upload of information by the device 108 to the database 104 over the network 106 can occur piecemeal, such that the rectifying step 508 and/or uploading step 510 is repeated (in either sequence according to design). In such case, portions/part of information of the device 108 is uploaded, with continued repetition in such manner to upload all information of the device 108, thereby initially populating the database 104 in the method 500. Although the uploading step 510 and rectifying step 508 are shown in FIG. 5 as occurring in initial population of the database 104 in the method 500, these and similar steps can be repeated from time to time, as to devices 114 and the system 100 as a whole, as desired or applicable in the implementation, such as to maintain and synchronize current and valid information of the database 104 from time to time with contact management applications of connected devices 114 and other similar applications and sources of information. In such situations, the synchronization via the steps 510 and 508 can occur automatedly, by manual initiation or instruction at the device 108 or otherwise within the system 100, or as otherwise desired and implemented in the system 100. Moreover, the uploading step 510 and rectifying step 508 are repeatable from time to time in order to maintain information synchronicity of the database with information in device and salesperson contact management systems, other software/hardware applications, and other resources external or internal to the system as the case may be according to configuration and implementation.

Each of the devices 114 communicatively connected to the network 106 and enabled to use the system 100, for example, each device like the device 108 used by the salesperson, performs the method 500, together with the server 102 and database 104, in order that the database becomes populated with all information of the devices 114.

Additional Population of Database:

Other information (in addition to information of the devices 114 on initial population) is included in the database 104, including, for example, by direct input or programming, from commercial or public listing services, as system-supplied data, and from conventional or other future data banks, databases, access services to information, Internet searching and retrieval, and other sources. Each device 108, from pluralities of the devices 114 accessing and using the system 100, contributes customer and sales relevant information to the database 104. Configurations and embodiments of the system 100 provide for various restrictions, aggregation, sharing, alerting, and other mechanics for availability and use of information.

Also, whenever a salesperson uses one of the devices 114, such as the device 108, to access the sales tool of the system 100, the salesperson inputs additional or substitute information, i.e., tokens, to the database 104 via communication of the device 108 over the network 106. In return for tokens of value contributed to the sales tool of the system 100 during use of the database 104 by the device 108 and its salesperson user, the salesperson is afforded various credit(s) that are registered and logged by and as information of the database 104. The credit afforded for any particular contributed value, as previously mentioned, can be measured or assigned in a wide variety of ways, such as by algorithm of the database 104 according to weighting of respective token items, from feedback of users about tokens, usage, and other characteristics, from extent and regularity of use, and others. Feedback of other users and of authorities/managers is particularly relevant in affording credit as to certain algorithmic configurations and implementations, and the systems and methods track, account and attribute the credit in accordance therewith by virtue of such collaborative/peer feedback. Alternately, value can be measured in other manners by the system 100, such as through records of each relevant contribution and contributor, statistical reviews, and the like, either through automation of the database 104 sales tool or by external manual or other consideration. As previously stated, the sales tool encourages participation and contribution by salespersons of information that populates the database 104. The credit(s), and the salespersons' desire to obtain credit(s), contributes teaming focus, uniformity, best practices, and greater/better information for sales efforts. Further operations and aspects of the sales tool and systems and methods are hereafter described.

Identification of Salesperson Relationships

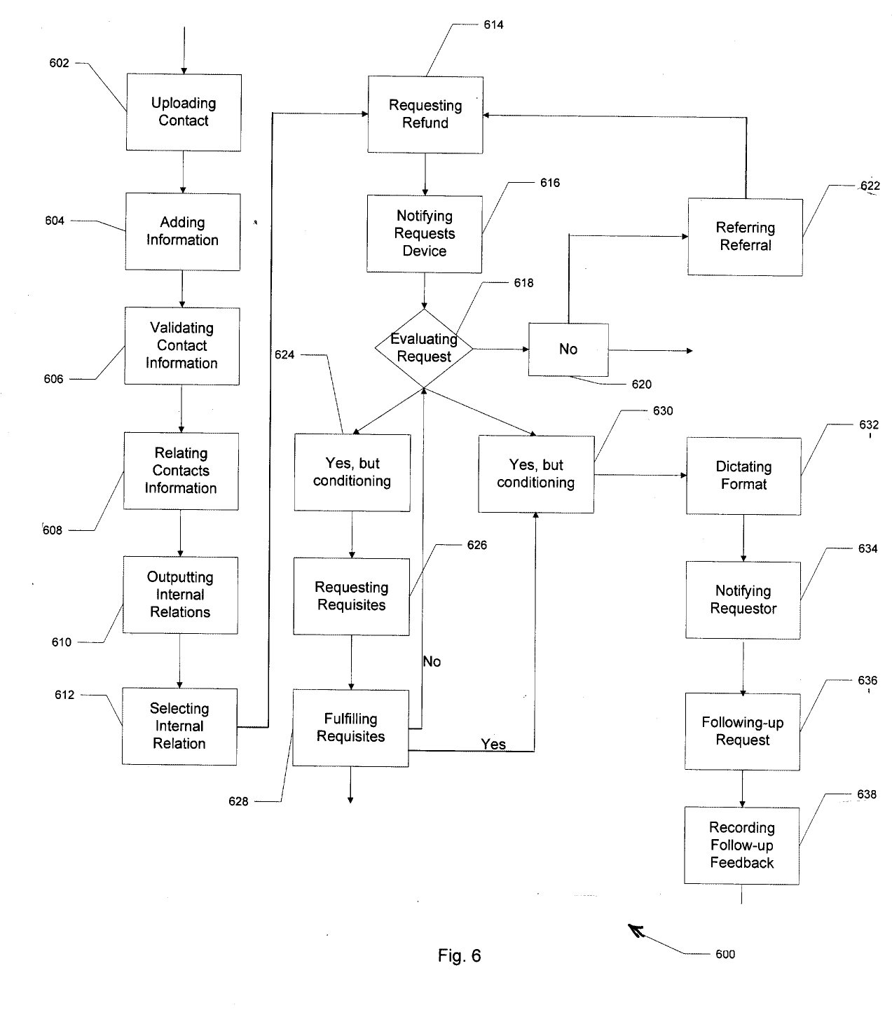

Referring to FIG. 6, in conjunction with FIGS. 1 and 2, a method 600 of the sales tool of the system 100 and method 200, and according to the foregoing, identifies relationships of salespersons using devices 114 and promotes shared relationship and other information in sales efforts. In the method 600, one of the devices 114 used by a salesperson, for example, the device 108, communicates over the network 106 with the server 102 and database 104 to interact with the sales tool of the system 100. In particular, in initiating such operations of the sales tool of the system and method, the device 108, via browser graphical interface, communicates with and to the server 102 and database 104.

Upon initiating operations of the sales tool, the method 600 continues with an uploading contacts step 602. In the uploading contacts step 602, the device 108 communicates to the database 104 a relationship contact, such as a person or company, known to the salesperson using the device 108, of actual or potential interest and relevance to sales efforts. The relationship contact is any data or information that the salesperson considers relevant to current or future new customers and sales opportunities, an information source for sales, a change in customer status or internal contact, a new contact for promotion, or any other of a wide variety of sales-relevant person and company information. In addition, the relationship contact can include information about whether or not the salesperson performing the step 602 is willing to introduce other salespersons to the contact, the public or private (or limited accessibility) nature of the contact and related information, limits, restrictions or conditions for contact use or introductions, and others. The communications in the uploading contacts step 602 are made through the browser interface at the device 108, and communicated over the network 106 to the server 102 and database 104. Alternatively or additionally, the step 602 is made via a plug-in or other hook or tie to legacy contact management applications or CRM systems of the devices 114 of the system 100, such as, for example, Microsoft Outlook or others. In such instance, the plug-in acts as a local application with a network interface to the sales tool of the system 100.

In an adding information step 604 of the method 600, the device 108 communicates to the database 104 further data or information of relevance regarding the uploaded contact of the step 602. For example, this can include the strength of the relationship of the salesperson using the device 108 to the contact, that person's willingness (or not) to leverage the contact and access the contact, the confidence level for information of the contact, and a wide variety of others. The adding information step 604 is performed via browser interface at the device 108, in communication with the database 104 and server 102 over the network 106. This step 604 need not be performed if there is not any additional information for the database 104.

The system, via the database 104 and programmed logic thereof/therefor, performs a validating step 606 as to information uploaded by the device 108 in the steps 602, 604 (and other inputs). For example, spellings, names, Standard Industry Codes (SIC codes), addresses and other characteristics or attributes of information to the database 104 are so validated. The validating step 606 need not be performed in certain configurations if so desired; however, accuracy and rectification of information of the database 104 is an important advantage, and the step 606 contributes to these aspects.

After the validating step 606, the database 104 performs a step 608 of relating the contact and other information uploaded by the device 108 to the database 104 in the steps 602, 604. The validating step 606 is performed in accordance with the relational architecture and configuration of the database 104 and related logic. In the step 606, for example, applicable tables, records, field and items are updated, added to, revised, substituted, and so forth, as required or desired.

The database 104, in conjunction with the server 102 and communications over the network 106 thereby to the device 108, outputs certain data of the database 104 to the device 108. The data so output to the device 108 regards internal relationships (such as within a company, a cooperative, an enterprise, etc.) for the contact then being addressed by salesperson user of the device 108. For example, if another salesperson within the company has a relationship with a particular contact of interest as addressed by the device 108, the identity of that other salesperson is made available at the device 108 for viewing by the user of the device 108.

In a selecting step 612, the salesperson using the device 108 can select from among identities of other persons (where there is more than one) having relationships with the applicable contact. An input at and by the device 108, communicated over the network 106 to the server 102 and database 104, is made by the salesperson user of the device 108 in a requesting referral step 614. The database 104 receives the request (corresponding to the selection from the step 612).

In a notifying step 616, the database 104 processes the request from the step 614. Then, the database 104 and server 102 communicate over the network 106 a request. The request is communicated to one of the devices 114 employed by the other salesperson that has relations with the contact. For example, an e-mail, instant message or other notification is communicated to one of the devices 114 of the other salesperson, or a message pertaining to the notification may be waiting for the salesperson the next time they log into the application.

Thereafter, in an evaluating request step 618, the other salesperson using the other one of the devices 114 can review and consider the request to the device 114 made in the step 616. The request can be considered and responded to (or not) in several manners. In each instance, actions by the other salesperson using the other of the devices 114 cause communications by that other of the devices 114 over the network 106 to the server 102 and database 104.

There are at least three possibilities for next step of the method 600 after the evaluating request step 618, as follows:

A first possibility for next step of the method 600 is a refusing step 620. The refusing step 620 is performed either (i) by the salesperson using the other device 114 and failing to take action at the other of the devices 114 in response; or (ii) by the salesperson using the other of the devices 114 sending a communication, via input at the one of the devices 114 to the database 104 over the network 106, to the database 104 that this other salesperson does not wish to be involved in the effort. In either case, this other salesperson, via the other of the devices 114, has an option to further refer on to another third salesperson the particular request from the device 108 in the step 614. If the request from the step 614 is referred on to another, then the method 600 returns to the step 614, albeit the step 614 is then performed by the salesperson using the other of the devices 114 to make the request to the third salesperson.

A second possibility for next step of the method 600 is a conditional accepting step 624. In the conditional accepting step 624, some request from the step 614 (either the original request or a referred on request, or so forth) is affirmatively acted upon by a salesperson user of one of the devices 114 to whom the request 614 has been communicated. However, the salesperson user of the device 114 qualifies or conditions the affirmation, such as by inputting to the particular device 114 a requirement.

The requirement is communicated in a requesting requisites step 626 by the device 114, over the network 106, to the server 102 and database 104. In the requesting requisites step 626, the database 104 and server 102 further communicates over the network back to the device 108 making the request in the step 614. The communication includes further requirements or conditions of the salesperson performing the step 626. For example, the step 626 can include such matters as scheduling requirements, conditions for contact meetings, and any of a wide variety of other possibilities.

If the salesperson using the device 108 and receiving notification of the requested requisites from the step 626 can fulfill the requisites, the salesperson inputs to the device 108 for communication over the network 106 in a fulfilling requisites step 628. In the step 628, input to the device 108 is communicated to the server 102 and database 104 and, as applicable, communicated on to the other device 114 making the requisites in the step 626. If the requisites are not fulfilled via the step 628, then the method 600 returns to the step 618 of evaluating at the other device 114 by the other salesperson. For example, several of these steps 618, 624, 626, 628 can occur, if applicable, prior to any finality of resolution and continuation of the method 600.

A third possibility for next step of the method 600 occurs either (a) after the step 628 and any requisites having been resolved, or (b) if the other salesperson, or a designated proxy of this other salesperson, using the one of the device 114 in the step 618 performs an unconditional accepting step 630. The unconditional accepting step 630 is a notification by the other salesperson, via the device 114 communicated over the network 106 to the server 102 and database 104, and on to the device 108, that the requesting referral step 614 by the device 108 is acceptable. For example, if the device 108 made a request for referral in the step 614 and the requestee/salesperson (or designated proxy, if applicable) is agreeable to the request, then that requestee, via the other of the devices 114 used by that requestee/salesperson, communicates back over the network 106 to the server 102, database 104 and device 108 that agreement to the request.

In a step 632, the salesperson acceptor of the request inputs, via one of the devices 114, any formatting dictates. The formatting dictates can include such matters as information about the contact, relationship, desires for meeting or introduction, or any other possibility. The formatting dictates from the step 632 are communicated over the network 106, to the server 102, database 104 and device 108, in a notifying requestor step 634. The formatting dictates are then made available to the device 108 and its user salesperson.

Further in the method 600, additional following-up step(s) 636 and a recording follow-up feedback step 638 are included. In the following-up step 636, the salesperson who responded to the request via one of the devices 114 and the salesperson using the device 108 can further correspond, over the network 106 and via the server 102 and database 104, in one or more communications. In the following-up step 636, for example, any salesperson involved in a contact effort can make comments, input, or feedback regarding the efforts and quality provided by another of the involved salesmen. Additionally, other information can be included. In the step 638, the information from the following-up step 636 is communicated to the server 102 and database 104. At the database 104, the information is logged and saved.

At each step of the method 600, communications using the sales tool occur over the network 106, between devices 114 and the server 102 and database 104. The database 104, as selectively programmed and designed, records and maintains indicia or attributes of the various use and communications. As previously mentioned, the database 104 includes programming and logic in order to attribute credits for uses of the sales tool. Although there are a wide variety of options and possibilities for the particular credits, how registered, applied, attributed and employed, the sales tool, via the network 106, devices 114, server 102 and database 104, accounts for the credits. In this manner, objective credit criteria are tied to salesperson efforts in the sales process of contacts, relationships, and the like.

Identification of Sales Conduct

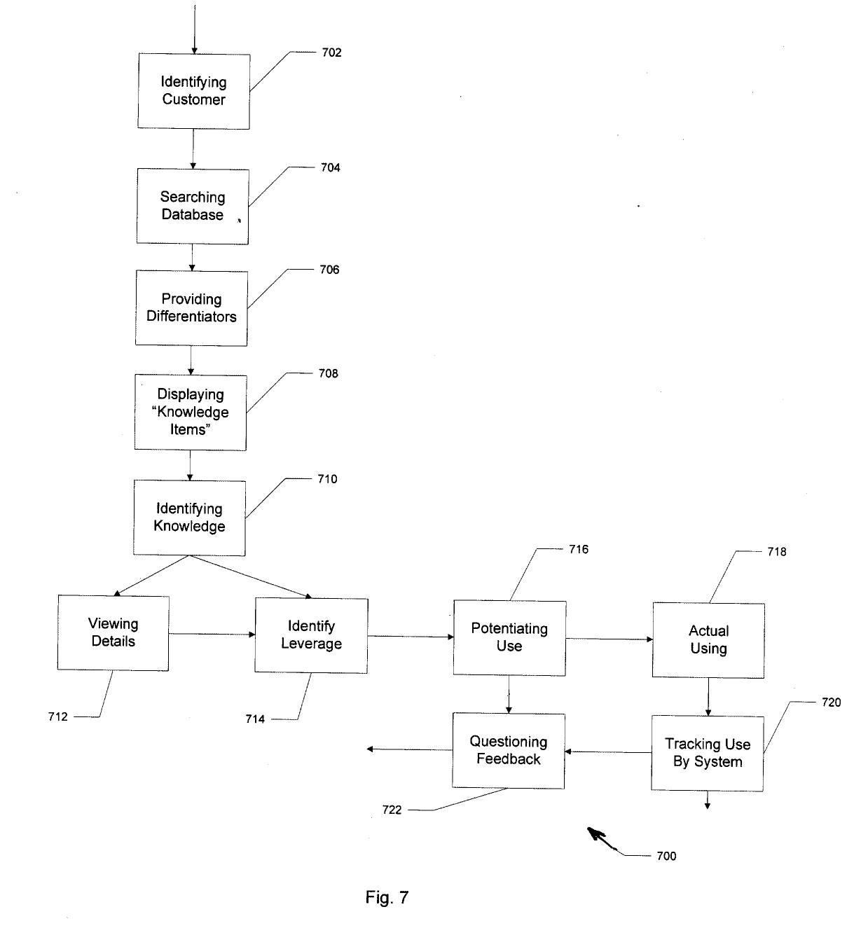

Referring to FIG. 7, a method 700 guides, plans, and directs sales efforts of salespersons utilizing the sales tool and systems and methods. In a step 702 of the method 700, a salesperson using one of the devices 114, for example, the device 108, identifies a customer or potential customer. In the step 702, the device 108, via browser interface, communicates over the network 106 to and with the server 102 and database 104. For example, the salesperson user of the device 108 inputs a new customer identity and information into the device 108, and the device 108 communicates the information to the database 104. The information input by the device 108 can include such matters as name, address, contacts, interests, product potential, and a wide variety of others.

In a searching step 704, the database 104 receives the information communicated by the device 108 and processes the information. The step 704 includes searching and parsing of database 704 records and information then saved through population. The searching and parsing in the step 704 is in accordance with programming and logic for the database 104 and its operations, and can include levels of interactivity with the salesperson via the device 108 and network 106 communications. Additionally, the particular information provided via the device 108 (and its salesperson) can drive/affect the step 704 and how it is performed.

Once the searching step 704 is completed, the results of the search—i.e., knowledge items such as competitive differentiators—are made available by the database 104. In a step 706, the differentiators are communicated by the database 104 and server 102, over the network 106, to the device 108. These differentiators are dictated by database 104 logic and programming, and give sale and customer specific information (or identifiers thereof) that are contained in the database 104 and can be obtained or used by the salesperson user of the device 108 through the sales tool. The results of the search are prioritized based on the feedback by the salespersons that have applied those knowledge items in their sales opportunities fitting similar situations (e.g. industry, product, etc.) such that the salesperson is exposed to the most relevant search results first.

Thereafter, various steps 708 of communicating additional results that are knowledge items occurs, either automatically or at the communicated request/direction from the device 108. The database 104 and server 102 communicated the knowledge items over the network 106 to the device 108. The device 108 can, for example, display at the device 108 for viewing by the salesperson, store at the device 108, be further manipulated or processed by the device 108 or otherwise, or other activity regarding the communicated differentiators and knowledge items.

At the device 108, the salesperson user of the device 108 communicates over the network 106 to the server 102 and database 104 in order to identify specific ones of the knowledge items that are desired for viewing and use. In an identifying knowledge step 710, the salesperson inputs to the device 108, through the browser interface, particular knowledge items of interest. This input is communicated over the network 106 to the database 104, and the database 104 returns the item information to the device 108.

The device 108 displays the item/information, and the salesperson views the display at the device 108. A step 712 of viewing details is thus performed. Prior to or after the viewing details step 712, the salesperson determines various items of the details that are of importance to the sales effort and the customer of interest. An identifying leverage step 714 is performed by the salesperson at the device 108. The step 714 is, for example, subjectively performed by the salesperson by selecting among information then available at the device 108, generating or parsing results of the information or therefrom at the device 108, or by otherwise further operating the sales tool through additional communications with the database 104 over the network 106, such as where the database 104 and its logic permit various operations and processing options to the device 108 and its salesperson user.

In a determining potential use step 716, the device 108, either itself or through communications over the network 106 with the server 102 and database 104, determines what information to use in the sales effort for the particular sale and customer at issue. For example, the various items determined in the identifying leverage step 714 can be weighted by value or content, or further details can be obtained, generated, or accessed at the database 104 or device 108. The salesperson using the device 108 evaluates the potential of using the various items, and provides feedback in a step 722 regarding the apparent value or worth of the items to the effort. This feedback step 722 is important in the method 700 for valuing items relative to available items and aspects of the database 104.

Once the salesperson user of the device 108 determines the items to be used in the sale effort, the salesperson, via printout or other processing by the device 108, actually uses the items for the sale in a step 718. After such actual use in the step 718, the database 104 and server 102 communicate over the network 106 to the device 108, or the device 108 because of the salesperson's initiation, to track use of the items in a step 720. In the step 720, the systems and methods maintain, via the database 104 and communications over the network 106 with the device 108, records and logs of the use of items. The step 720 provides additional mechanism by which the items are valued through the interaction and database 104 storage and relations.

After the step 720, the feedback step 722 again requires, or allows, the device 108, and its salesperson user therewith, to provide assessment to weight and value items and the sales tool use. The database 104, via the server 102 and network 106, communicates to the device 108 requests or questioning for feedback purposes. These communications are in accord with logic and programming for the applicable use of the sales tool. Also, the device 108 can be employed by the salesperson to input for these purposes, as desirable and without prompt or request.

Thus, the method 700 provides feedback, including confirmation, valuing, assessment, and the like, for the sales tool. This feedback serves for verification and betterment of information and processing by the sales tool. The feedback also further directs later sales efforts through historicity inherent in the database 104 operations and guidance.

Credit for Sales Process Facilitation Tool Usage and Valuable Token Contribution

Referring to FIG. 8, in addition to the looped feedback and best practices sales efforts via the systems and methods of the embodiments, a method 800 of the systems provides for objective registry of salesperson efforts and contribution. This objective registry is by means of credits, as previously mentioned. Because salespersons will pursue credits, as they may be tangibly applied in a company or other environment, use of the systems and methods is encouraged and promoted, and further the operations and information of the systems and methods is refined for best practices.

In the method 800, a step 802 is performed by the device 108, through the salesperson's use, by input of a token. As previously mentioned, the token is any item of information, use, or other data that indicates or has indicia of value contributed by the salesperson user of one of the devices 114, such as the device 108, to the systems and methods, in particular something of value to facilitating the sales process in which the system and method are employed. For example, an input of a new contact information or the like and/or the making of the contact information available through the system and method to other users can be credited, such as if the salesperson makes the contact available via the system 100 to another user upon request from the other user for contact access and/or similar scenarios. In essence, it is intended that credit is encouragement for contribution, participation, effort and the like; thus, credits that may apply in any particular situation are relevant to the environment, application, and desired objectives for the system 100 and alternate configurations of the system 100 allow for variation to further these factors and others.

The database 104, as has been described, registers and records credits and relates the credits to each particular salesperson user. The credits can, thus, be employed as measures of worth, value, contribution, cooperation or other attributes of the salesperson. The credits are employable in compensation determinations, review practices, and so forth, as concerns the salesperson's employment, advancement and the like. In each instance of use of the sales tool by the salesperson via the device 108, communications between the device 108 and the server 102 and database 104 over the network 106 allow for registration of such use in the database 104. In this manner, the database 104 records and collects credits attributed to each such use.

After the inputting token step 802, the database 104 upon receiving the token then relates the token to information or data in a step 804. The particularities of the step 804 are dictated by programming, configuration and logic of the database 104, in keeping with the embodiments. In a step 806, the database 104 attributes a weight or value to the token. This weight or value in the step 806 is programmed in accordance with desired operations and effects. In certain embodiments in which the database 104 is operated as a cooperative offering by a hosting provider, such as by subscription access or the like, the weight or value can be uniformly applied to users as per the configuration instigated by the hosting provider. In situations of company (or other group) operations maintained internally to the company, the weight or value can be programmed and set as the company dictates or otherwise.

In a step 808, processing or other interactions by the database 104, per its programming and logic, are performed as to the various values/weights for tokens. For example, via the feedback mechanisms, certain tokens can be afforded greater weight as importance to the sales effort is determined by the database 104 programming, logic, or otherwise. Further, the steps and operations of the systems and methods can be automatedly, or otherwise, varied or adjusted per the step 808 of interacting by the database 104 with the values.

A step of testing validation 810 is performed in the method 800 as to each value. In the step 810, the testing is per operations of the database 104, and can include communications over the network 106 with the device 108 or other devices and others. The testing validation step 810 also includes any new or changed values, from time to time, in order to ascertain whether or not the values are valid. For example, if a value is initially attributed to a particular item of information provided to the database 104 by the device 108, this value can be related via processing at the database 104 to other values. A wide variety of variations are possible in operations of the database 104, its processing and logic, in testing validation of values in the step 810. Feedback through the systems and methods, by devices 114 and their respective salespersons users, provides measures of worth, usability, and quality and others, that are then employed via the database 104 in the testing validation step 810.

In a step of surveying results 812, the database 104 communicates over the network 106 via the server 102, to the device 108 in order to request and receive tokens, and to process and accredit credits and values to credits. As previously mentioned, at several steps/stages of operations, requests for information, input and assessment are made to the device 108 used by the salesperson. These requests are initiated through operations of the database 104 at the time made, and are communicated by the database 104 through the server 102 over the network 106 to the applicable devices 114. Additionally, at the completion of a sales effort using the sales tool, a more comprehensive survey is requested and obtained by the database 104, such as in return for added credits or the like to the salesperson using the device and responding. In each such event and operation, the feedback and surveying results step 812 obtains verification, validation, better guidance and operations, and other sales and customer relevant objectives for the sales tool, including the database 104 and its operations and information. Collaborative feedback and filtering is thus effected and included.

After the step 812, a step 814 of rectifying value is performed by communications over the network 106 between the database 104 and server 102 and the device 108. In the step 814, the salesperson using the device 108 further communicates in order to rectify and correct information or other aspects attributed value by the systems and methods. Additionally or alternately, others can perform the step 814, such as is dictated by company management or otherwise; for example, over time, results of sales efforts can be assessed and evaluated in order to inform values for the systems and methods. In any event, the database 104, through communications with devices 114 in sales efforts, attributes values and is involved in rectifying values automatedly or through external or other input or design.

Once feedback in the method 800 via the rectifying step 814 is complete, the method 800 continues with a rating effort step 816. The step 816 is performed automatedly by the systems and methods, such as by the database 104 per its logic and programming. Alternately, the step 816 is performed in conjunction with the database 104 through external review and input, such as by company management or the like. The rating effort step 816, in any event, is registered and made available by the database 104. For example, ratings from the step 816 of the salesperson using the device 108 are communicated to the device 108 for review by the salesperson, either automatically, periodically, on request or otherwise. Further, all salespersons and users of devices 114 can be permitted to view aggregated, or collections of aggregated, ratings and other results. Moreover, various sorting and processing of ratings and related data are possible. The database 104, per its logic and programming or otherwise, can provide the operations in the step 816.

Example

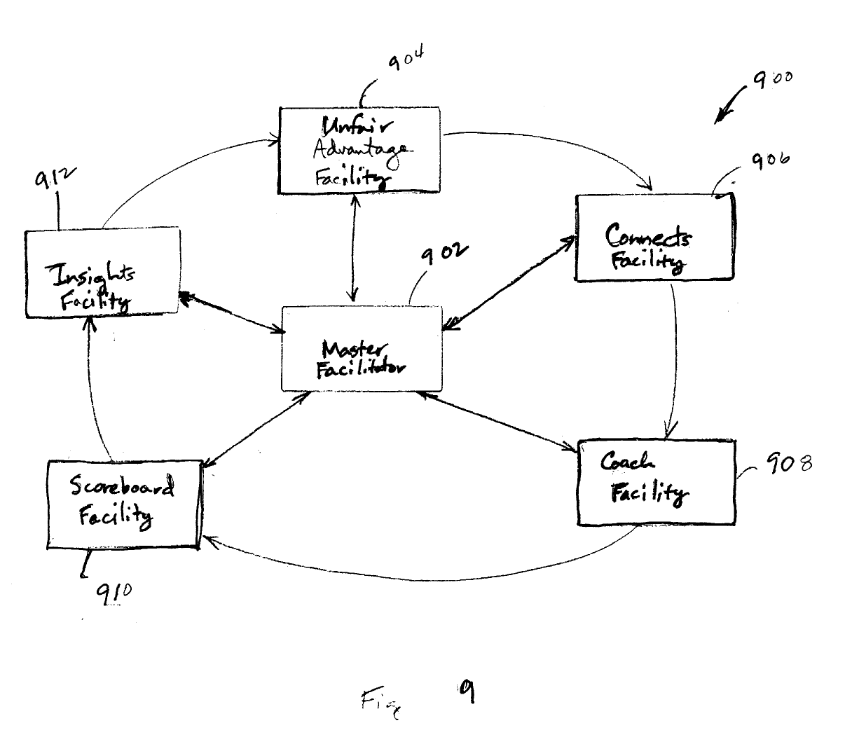

Referring to FIG. 9, a generalized conceptual illustration of a sales process facilitation tool system 900, in accordance with embodiments of the systems and methods herein, includes five sale process facilities 904, 906, 908, 910, 912 and a master sales process facilitator 902. In operations, the system 900 implements a sales process according to a best/better practices plan and guidance. The system 900 is implemented in software and includes a database of sale and sale process facilitation information and operations. The database schema 2700 of FIG. 27 is an example for certain embodiments of implementation. The system 900 is operable through an Internet browser or plug-in of a communicative device. Network communications of and among communications devices direct and control the operations of the system 900, for example, through computers and other devices capable of network data communications with and in the system 900 and its database.

The system 900 is controlled by and from the master facilitator 902. The master facilitator 902 presents an interface display on a user communications device. The facilitator 902 acts as a portal to the facilities 904, 906, 908, 910, 912 and also as an access interface for network communication of the system 900. The database and server previously discussed is an example arrangement for operations of the system 900. The salesperson devices previously discussed and that communicate over the network with the server and database is an example design for user access and operations to the system 900.

Through interactions with interfaces of and through the master facilitator 902, the facilities 904, 906, 908, 910, 912 are controlled and directed for operations thereof in the system 900. The master facilitator 902 can invoke, by interactive directive of a user at a communications device, each of the respective facilities 904, 906, 908, 910, 912. Additionally, the interfaces of the master facilitator 902 provide ready access to various information and next acts and steps for sales process facilitation. Although operations of the system 900 can proceed from and through the master facilitator 902 as generally desired by the user of the communication device on which the interface is displayed, an exemplary operation proceeds as hereafter described.

An unfair advantage facility 904 is typically first invoked in operating the system 900 for a new or continuing sales opportunity. The unfair advantage facility 904 is a sales process plan and guide. The facility 904 provides primarily information display to the user at the communications device, including strategy plan for best practices, stage of completion and next steps in sales process, certain details of completed stages and steps, and other similar data.

From the unfair advantage facility 904, the system 900 proceeds to a connects facility 906. The connects facility 906 is a sales opportunity entree for entry of new or additional data about the opportunity from the user device and also for recap of already entered and available data in the case of a continuing opportunity of interest. Upon entry input of sales opportunity data, either new or additional as the case may be, the connects facility 906 triggers searching of sales database information regarding contacts and referral resources. For example, the searching obtains from data then residing in the database any company-internal or other contacts, relationships, and resources to sales-relevant items and issues as to the particular sale opportunity of interest at the instant. The connects facility 906 includes referral and contacts request operations, in order to seek and allow response from other users and those associated with the system 900 for contribution, participation and other efforts and assistance in the sale opportunity. Any response information obtained back from the requests is indicated and available, as to current state from time to time during sales proceedings, to the user at the communications device through the connects facility 906.

A integrated coach facility 908 provides a plan of action, scheduling, and other “coaching” for the sales proceedings. The coach facility 908 includes request for additional input by the user at the communications device, such as regarding the sales opportunity and details thereof. Certain of the input that can be input includes potential sales products, value, and similar items relevant and of interest to the opportunity, competitive products and companies, and choice among particular options that may be available in proceedings to facilitate the sales opportunity and advance sale progress. Additionally, the coach facility 908 provides various of such information, as well as other available information of the database, for display to the user at the user communications device. Various opportunities and scenarios are presented automatedly by the coach facility 908, and feedback and ranking/rating of values of aspects of sales processes and facilitation from information, persons, plans and the like are both requested and accessible.

At times during sale progression, for example, after a sale is consummated or efforts discontinued or at stages during sales efforts, a scoreboard facility 910 aggregates and summarizes sale and customer relevant indices, practices, and other aspects of the system 900, its data and operations. Additionally, credits or other values attributed to salespersons using the system 900 and involved in the sale opportunity are gauged and available for access and display at the communications device. For example, collective or segregated sales successes, contributions, and participations are tabulated so that those obtaining corresponding data of the database of the system 900 can relatively or otherwise rate or rank various efforts and contributors, or the like.

Additionally, the system 900 includes an insights facility 912 that gains further feedback data and provides statistical and other information of the database as to sales and processes. The insights facility 912 can, for example, be operated and used to assess worth of various information, activities, efforts, contributions and other sales proceedings and weight accorded as facilitating sales processes. Additionally, the insights facility 912 provides reporting, accounting and other features, as applicable for the application of the system 900.

Various example interfaces that are displayable at a salesperson communicative device in use of the system 900, as to the various facilities thereof, are hereafter described.

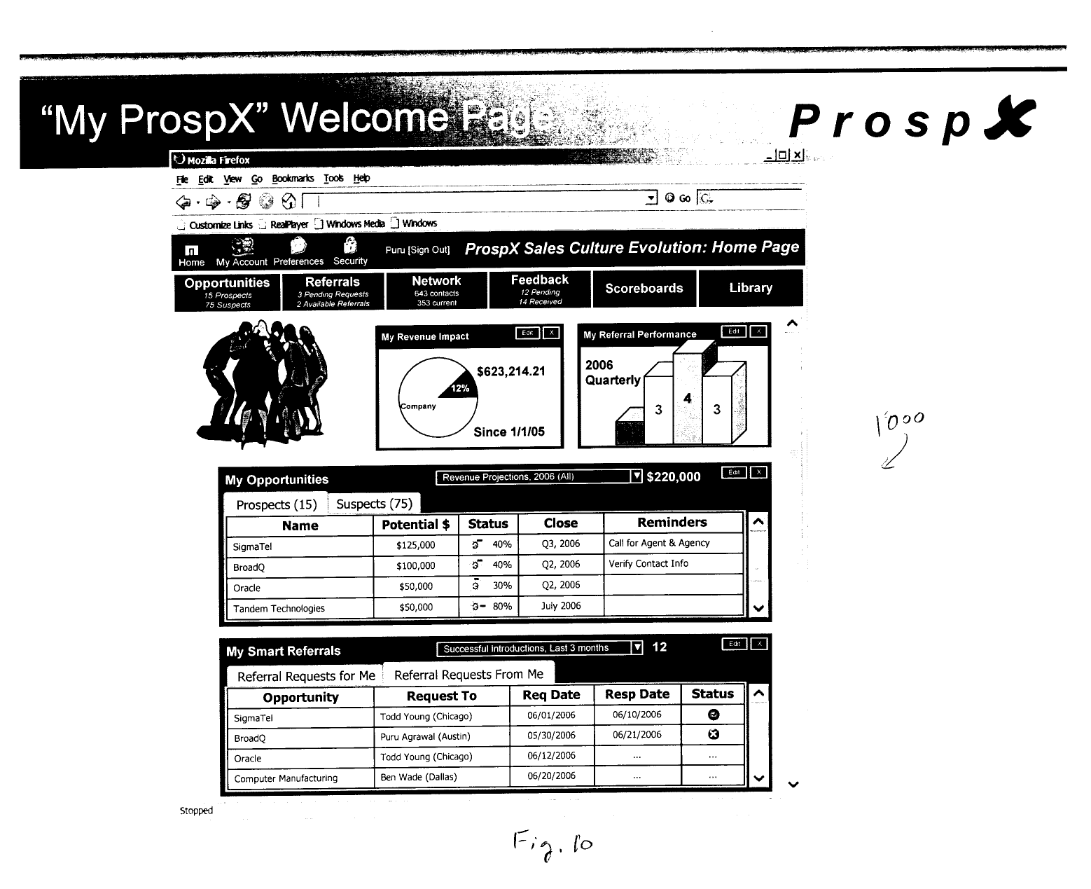

Referring to FIG. 10, a first interface 1000 is an example of a browser graphically viewable and interacting communication by the database 104 to one of the devices 114 over the network 106. The first interface 1000 includes information for a salesperson user of one of the devices 114, such as the device 108, regarding the salesperson's sales criteria of the systems and methods. The first interface 1000 provides information about current/present sales opportunities, referral states, sales revenue contributions, referral cooperation, and others. The first interface 1000 also provides an input segue for the device 108 in order to access other features of the systems and methods available via the database 104.

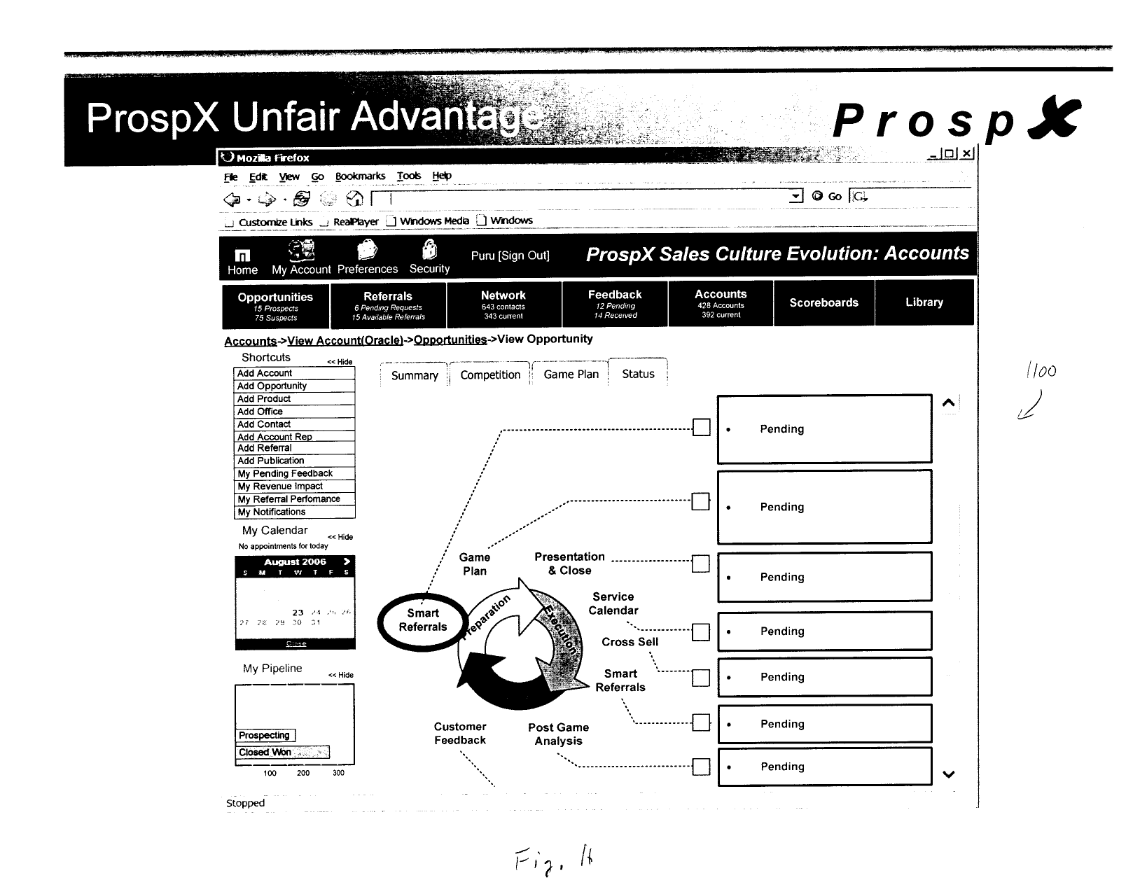

Referring to FIG. 11, from the first interface 1000, a next display can be an account status interface 1100. The account status interface 1100 changes, and is viewable at varied times throughout use of the system 100, to show progress in account efforts utilizing the system 100.

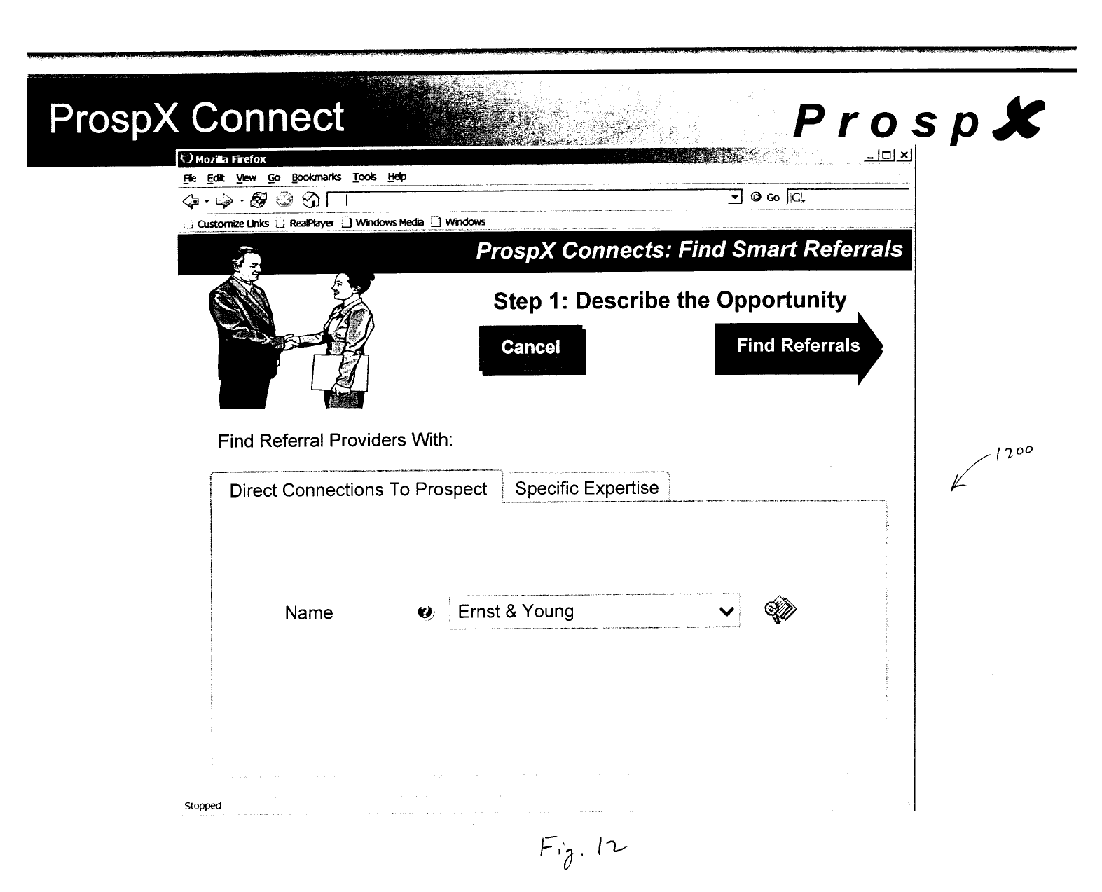

Referring to FIG. 12, a next input and display can be to a referrals interface 1200, accessible through input to the first interface 1000 or otherwise. The referrals interface 1200, for example, is displayed at the device 108 and enables referral operations of the systems and methods. In the method 600 of FIG. 6, as an example, the referrals interface 1200 is displayed at the device 108. Through the referrals interface 1200, the device 108 operates to perform the method 600.

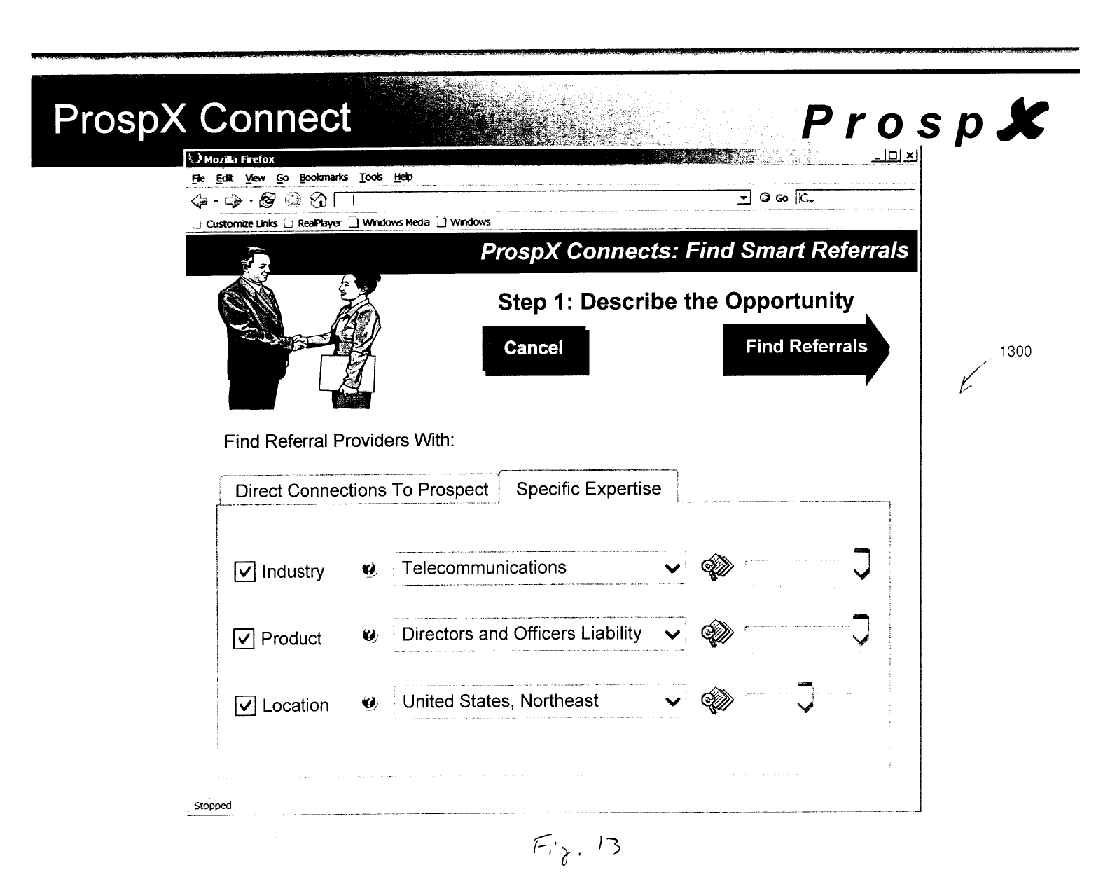

Referring to FIG. 13, the referrals interface 1200 of FIG. 12 includes additional tab for select display of added referral information and operations of the systems and methods. For example, additional details of relevant referral information is selectable and requestable through the tab of the referrals interface 1200.

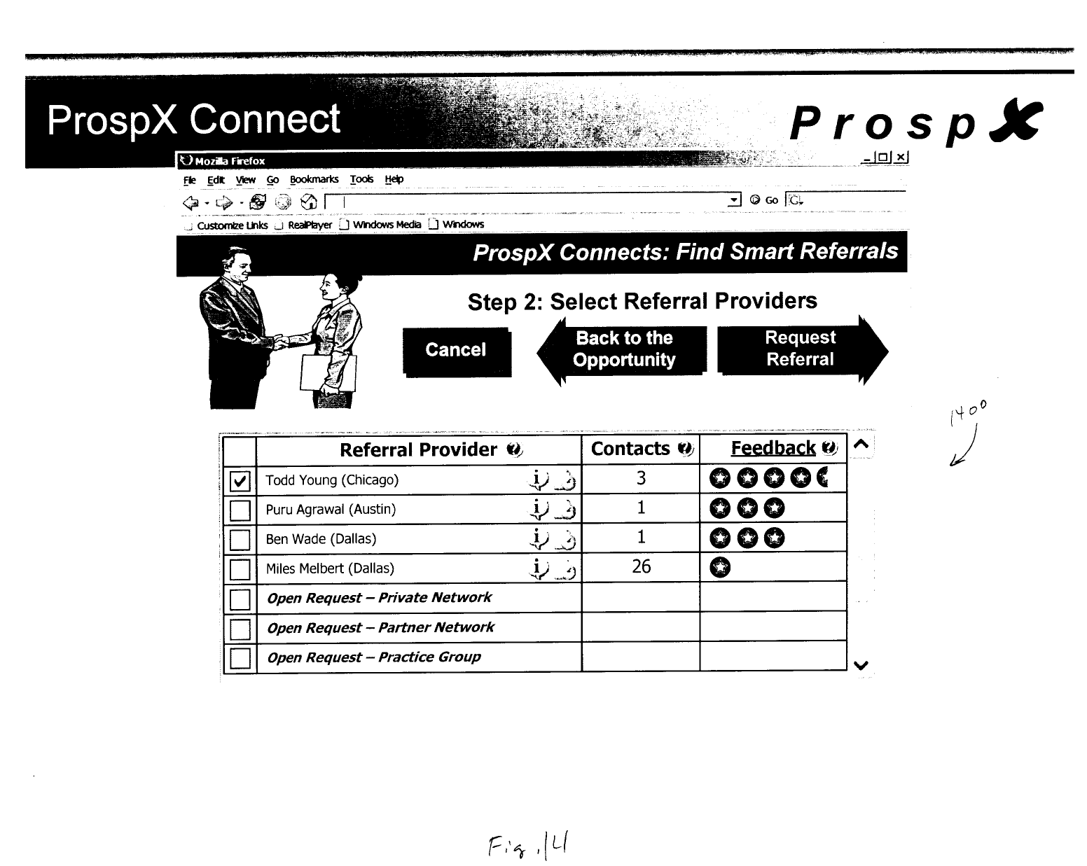

Referring to FIG. 14, in the method 600 and through input in the first interface 1000 and other steps of the method 600, a selecting referrals interface 1400 is displayed at the device 108. The interface 1400 corresponds generally to the steps 610-638 of the method 600. The interface 1400 provides access to the database 104 and its operations in the method 600.

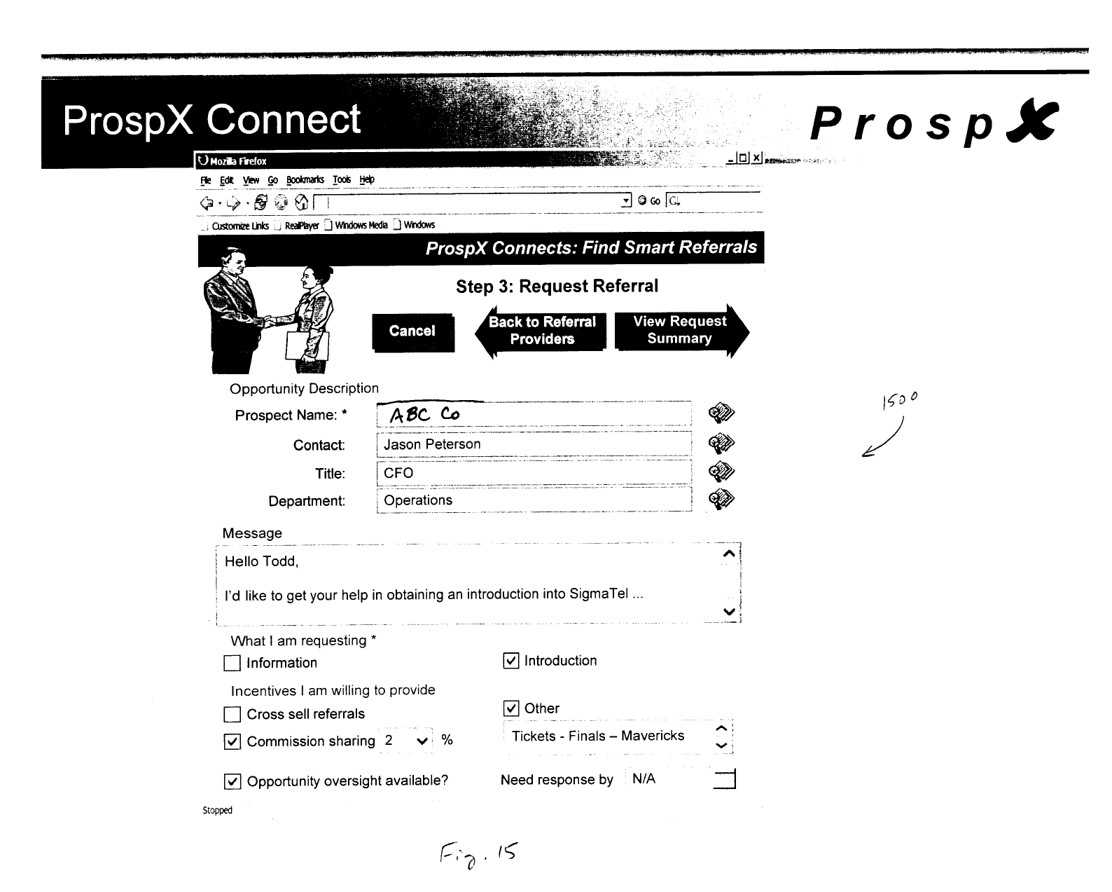

Referring to FIG. 15, from input to the selecting referrals interface 1400, the method 600 proceeds upon selection of referral request via a requesting referral interface 1500 displayed at the device 108 in the method 600. The interface 1500 allows collaboration of and with other users of the systems and methods, by making of request to such others. Upon making request to another user or to the system, the network of the system facilitates communication of request, response, feedback and the like between and among users. The response and feedback facilitation is included in the method 600, in addition to other aspects of the method 600, for crediting and valuing operations, as well as facilitating collaboration and collaborative filtering of information of the systems. Other of the interfaces, inputs, response, feedback and other aspects are implemented through the displays and user interactions with the various interfaces and details therein.

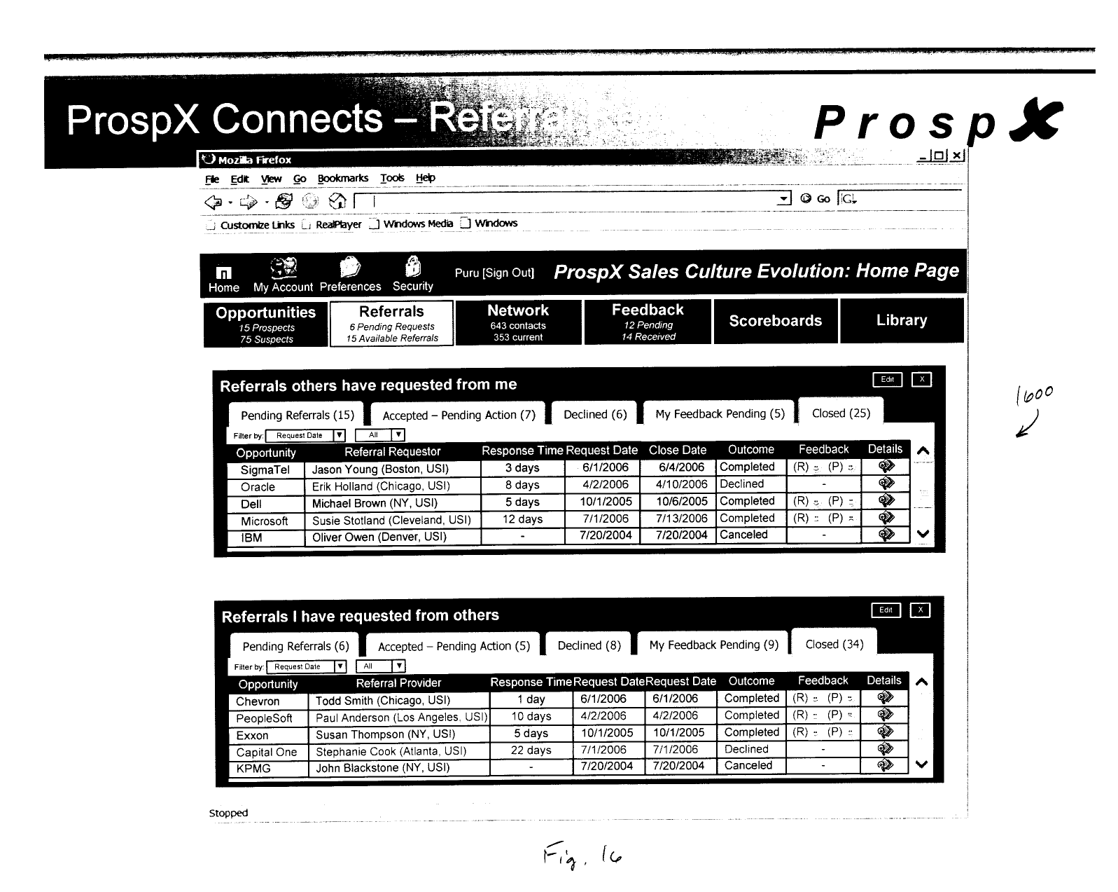

Referring to FIG. 16, a referral results and response interface 1600 is displayed to the user on input request or otherwise. Various details of referral requests, responses, feedback and other sales information of relation as to referrals, contacts, and instances is provided.

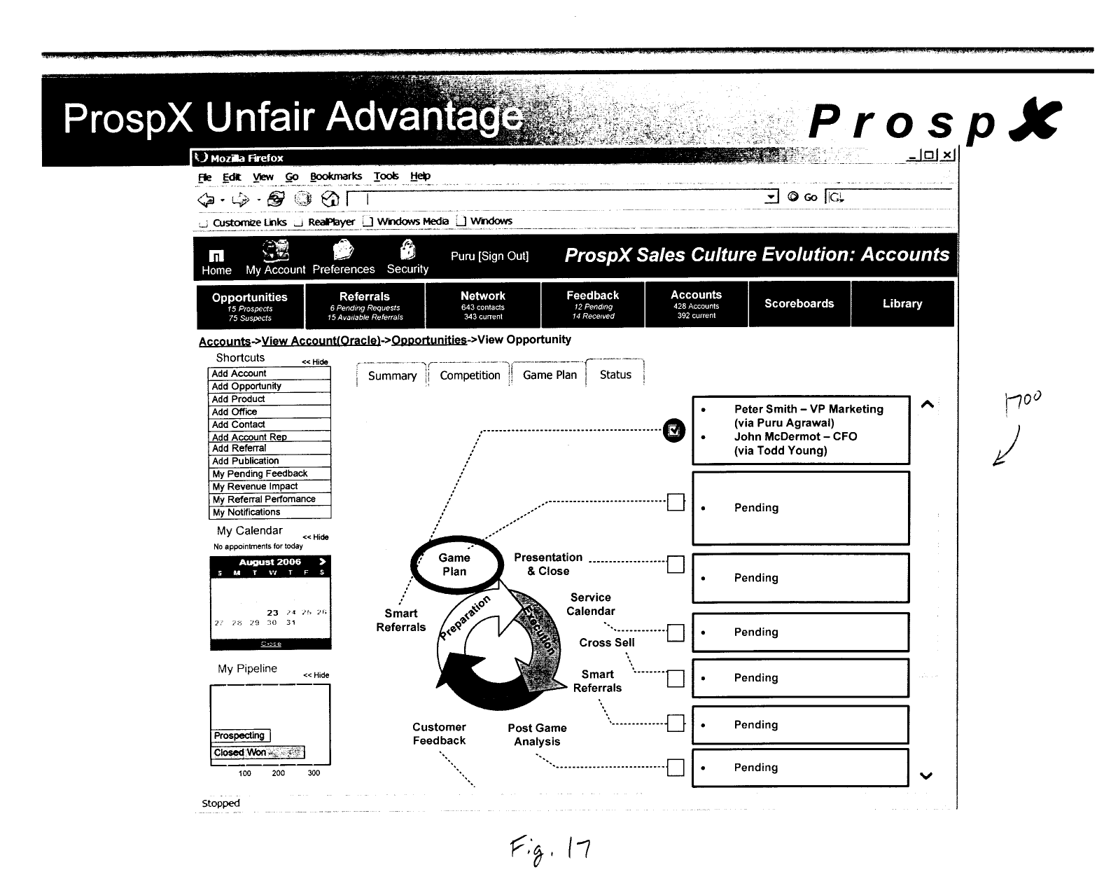

Referring to FIG. 17, the account status interface 1100 of FIG. 11 is displayed as an added account interface 1700. The interface 1700 provides status information of the account at stages/steps of the method 600 in using the system 100.

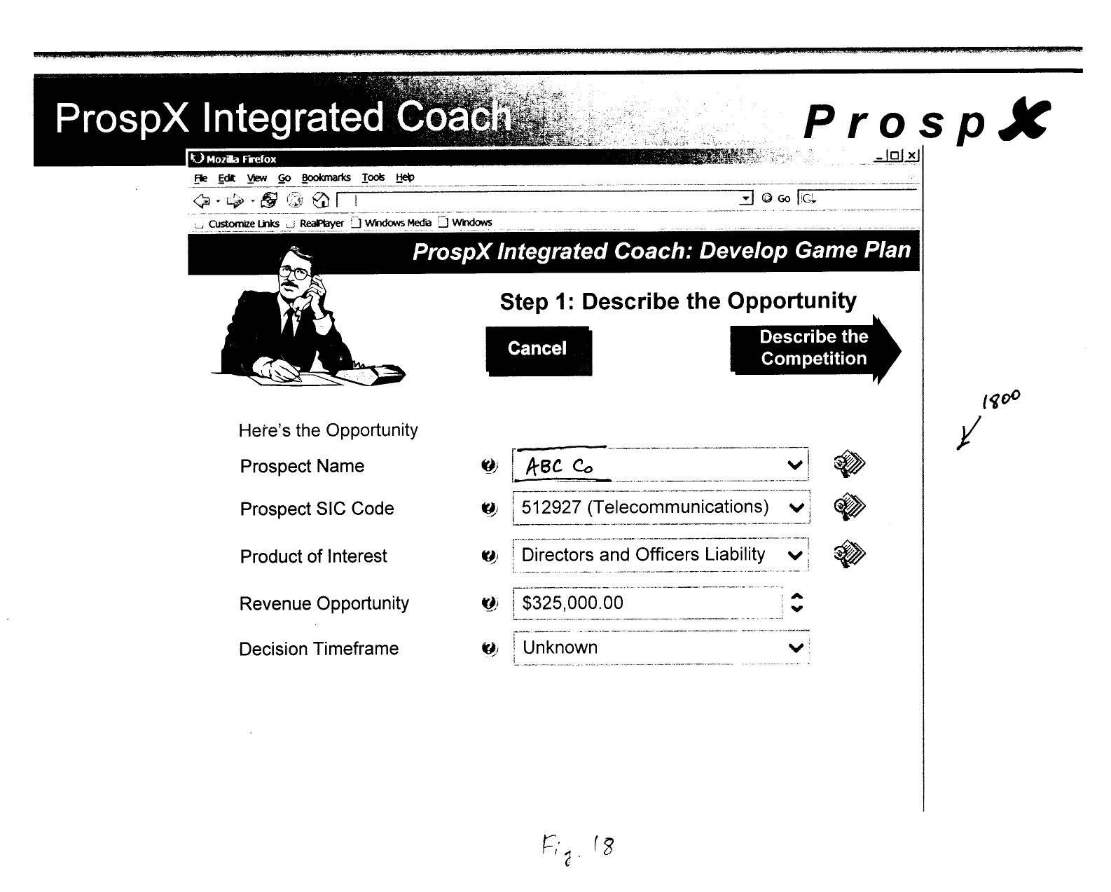

Referring to FIG. 18, a sales interface 1800 is an example of a browser viewable and interacting communication by the database 104 to the device 108 for a sales prospect or effort, such as corresponding to the method 700 of FIG. 7. The sales interface 1800 is accessed through the first interface 1000 or as otherwise arranged. The first interface 1000 includes information for a salesperson user of the device 108 regarding the sales situation then of interest for the device 108. The sales interface 1800 can, for example, require input from the device 108 by the salesperson user as to a current sale opportunity. In this instance, the step 702 of the method 700 commences with input by the salesperson via the device 108 to the sales interface 1800 and communication back to the database 104 over the network 106. Otherwise, the sales interface 1800 serves as segue to further actions in an existing sale opportunity or the like.

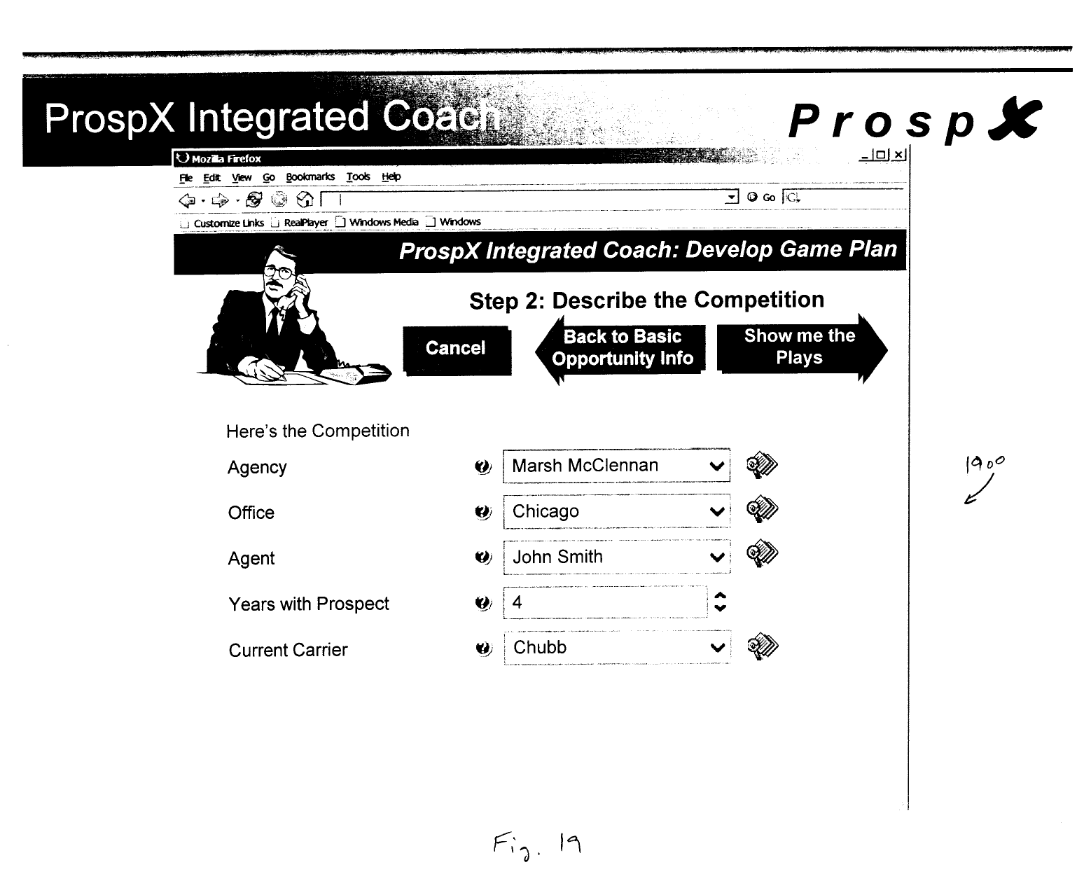

Referring to FIG. 19, a sales approach interface 1300 includes various input requirements and output display at the device 108 of sales-related competition information. The sales approach interface 1900 is automatedly invoked at the device 108 per the programming and operations of the sales tool via the database 104 or is otherwise accessed through input or action at the device 108. The activity at the device 108 with the sales approach interface 1900 is communicated over the network 106 to the database 104, as with other interfaces and actions.

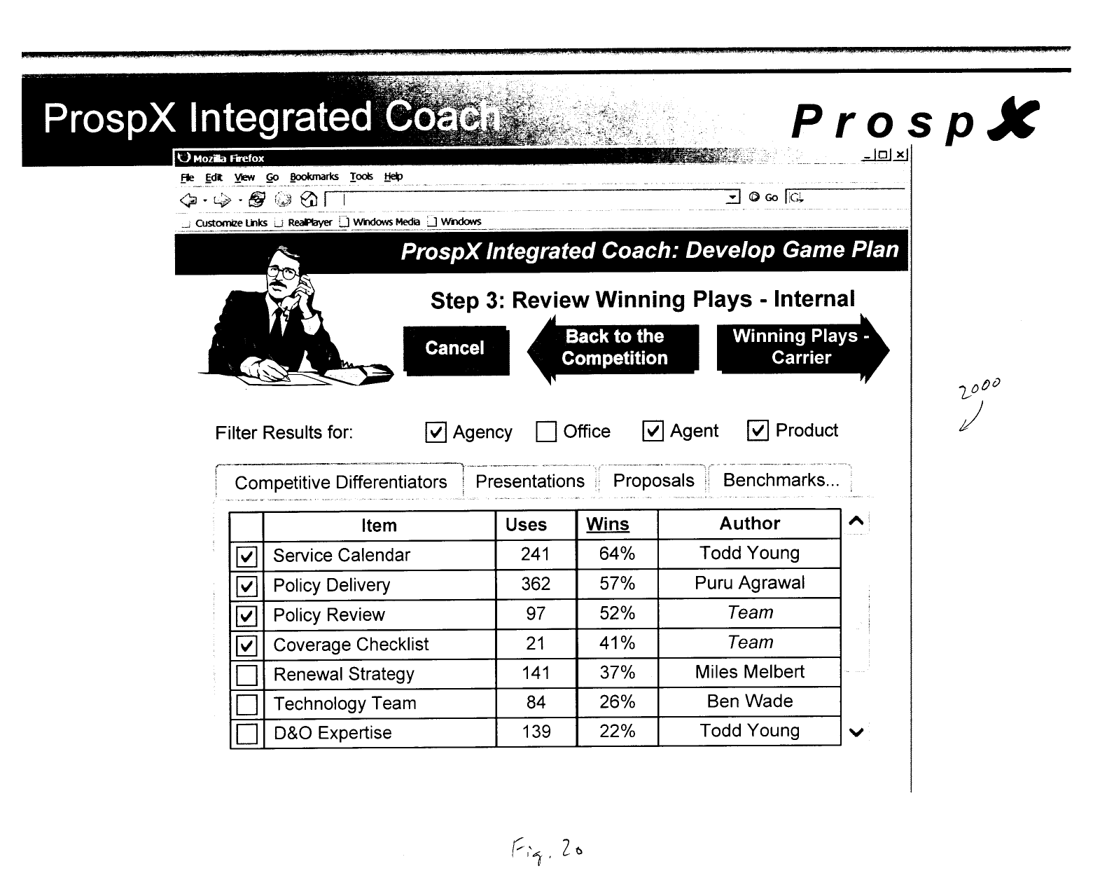

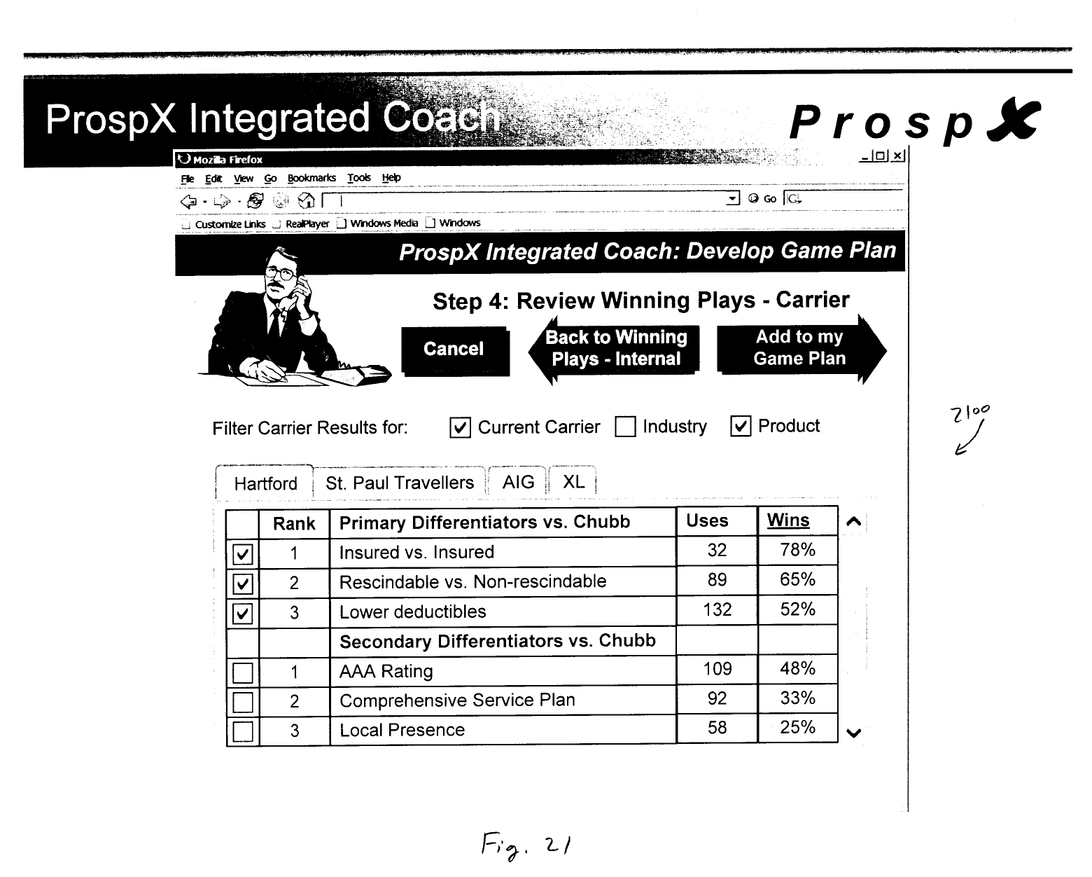

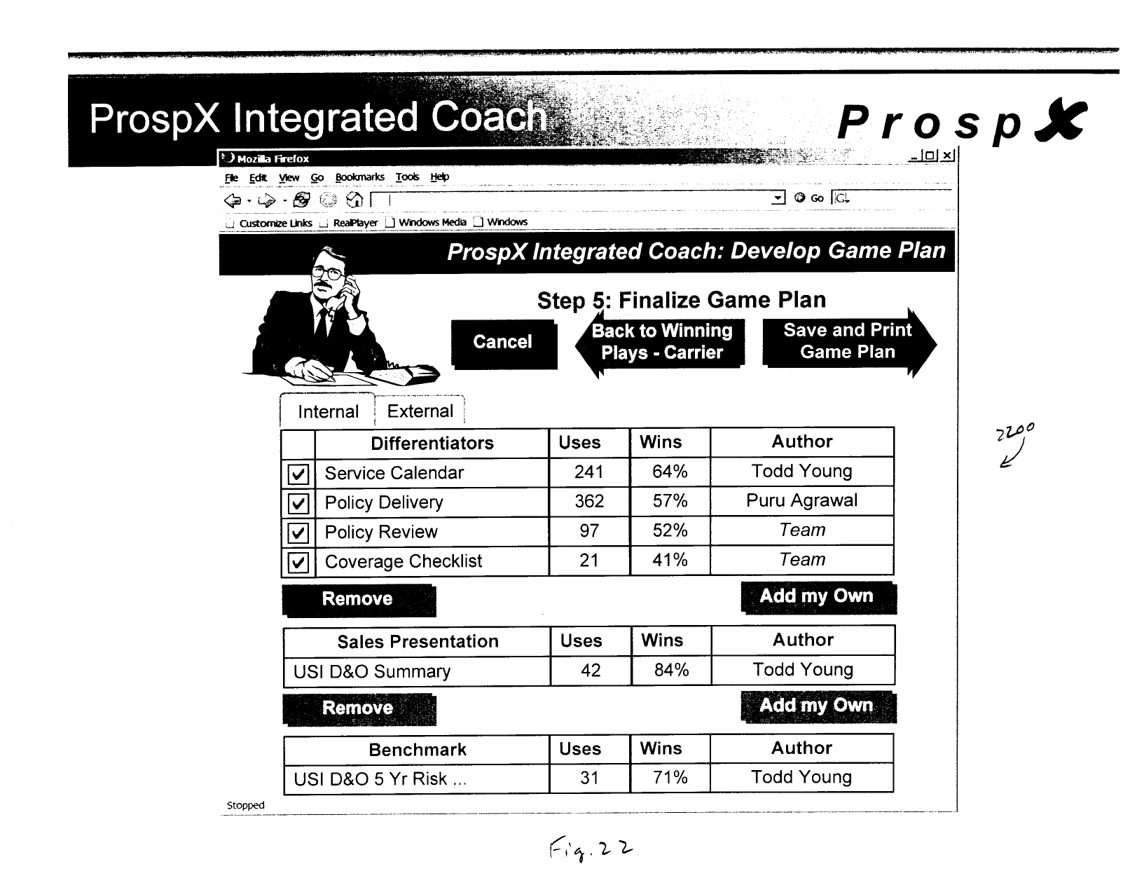

Referring to FIGS. 20-22, additional interfaces of the sales tool that are viewed at the device 108 and access the database 104 over the network 106 include a sales effort schedule interface 2000, a preliminary sales plan interface 2100, and a final sales plan interface 2200. Each of these interfaces 2000-2200 corresponds to actions involving access over the network 106 by the device 108 with the database 104, and additional steps of the methods. Of course, any particular use of the sales tool can involve various ones of the interfaces and sequences thereof, in keeping with the embodiments. Each interface at the device 108 in the methods can require input, output, feedback, or other action or interactivity. Credits and the like for token inputs, and other mechanisms, are coordinated and invoked by the database 104 through the interactivity and network 106 communications thereof.

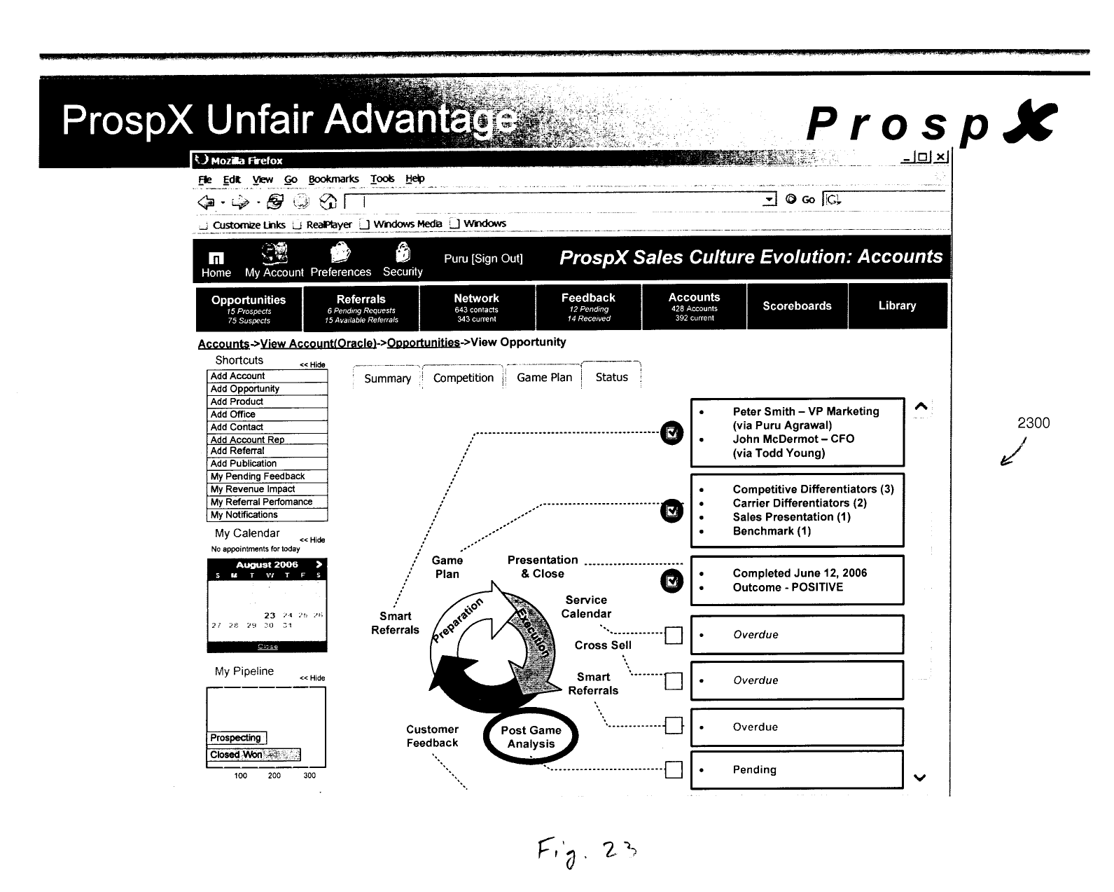

Referring to FIG. 23, a sales account recap interface 2300 displays the account interface 1100, 1700 showing additions from process steps and system use via the foregoing. The interface 2300 provides pointed status information, steps undertaken, and other aspects of and related to the account of relevance.

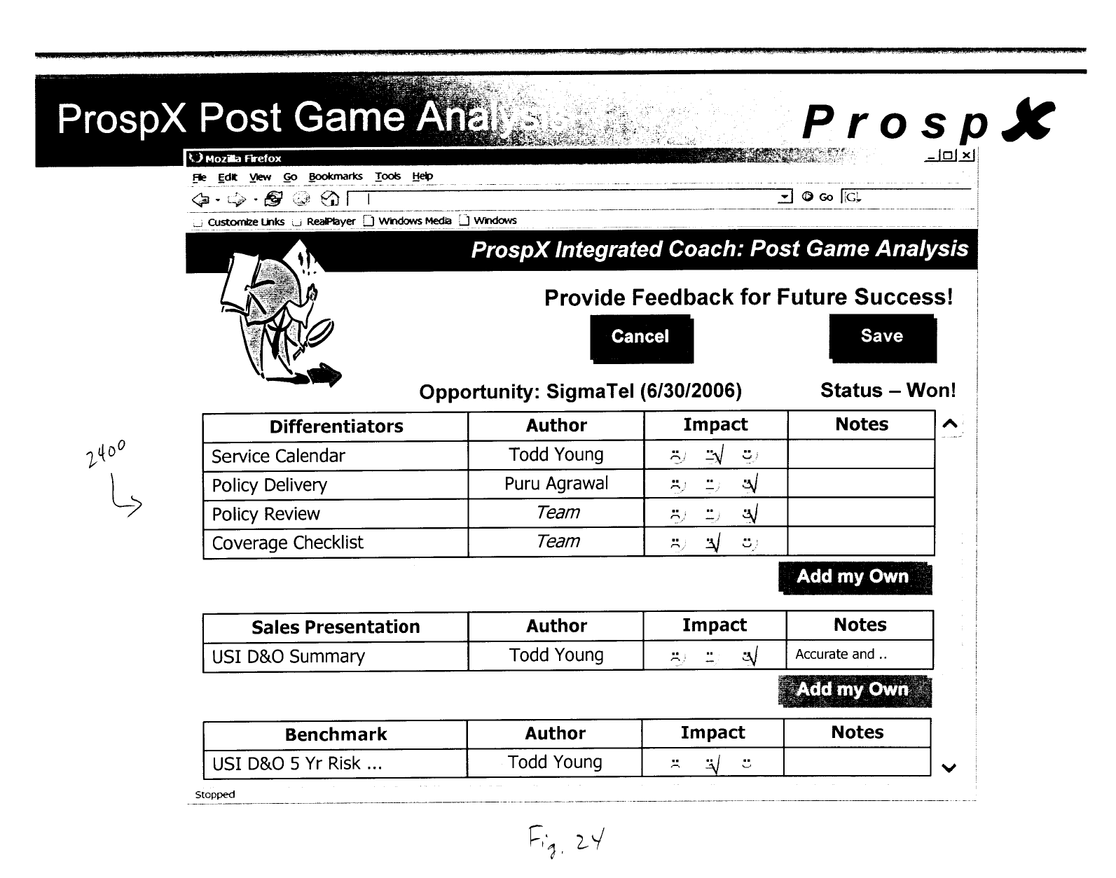

Referring to FIG. 24, a feedback interface 2400 is an example of a feedback request of the database 104 viewable at the device 108. Of course, the particular appearance and content of the feedback interface 2400 depends, at any point in the use of the sales tool, on the particular request(s) for feedback made. Interactivity and network 106 communications between the device 108 and database 104 are invoked.

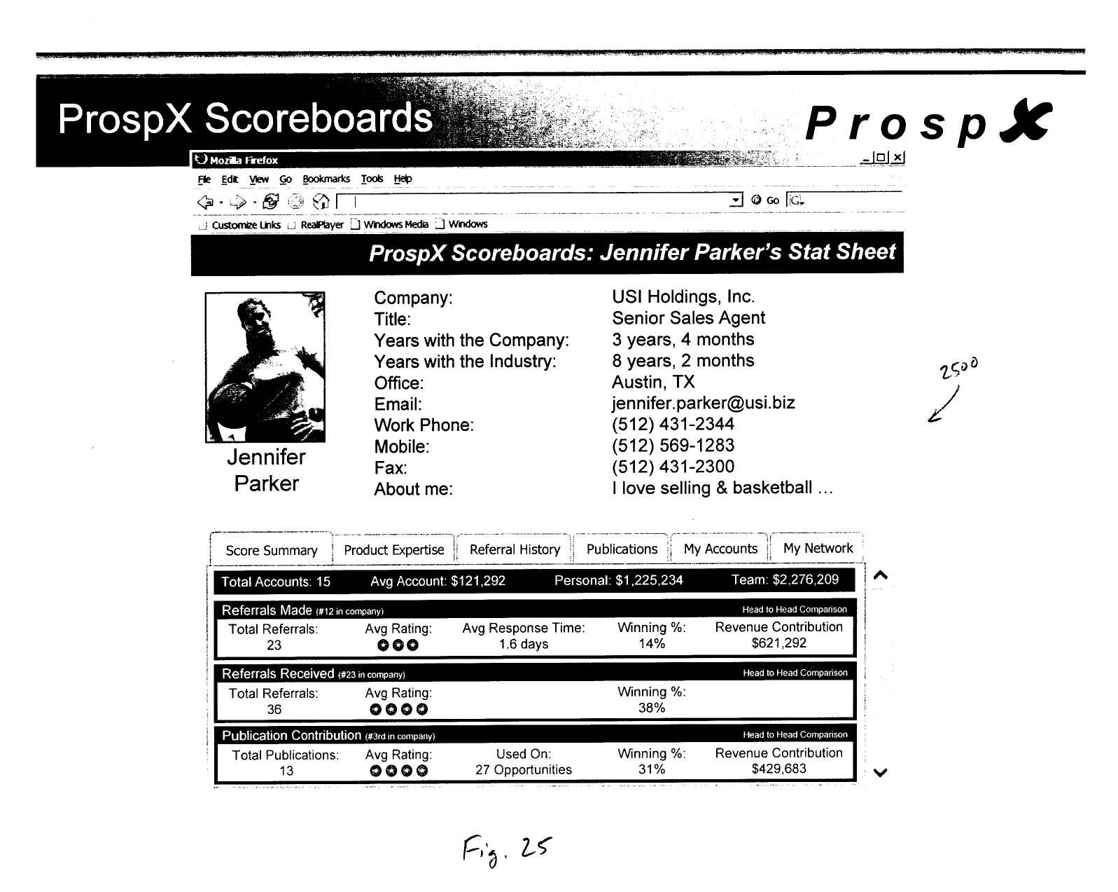

Various other reporting and summaries of sales actions and efforts, as to particular sales and aggregated, are available by operations of the database 104 and through network 106 communications, according to system and method design. Referring to FIG. 25, one such other report of the systems and methods is an individual credit and stats interface 250000. The interface 2500 is viewable, for example, at the device 108, if requested by the device 108 through communication to the server 102 and database 104 over the network 106. The interface 2500 provides relative credit values attributable or attributed to each salesperson of interest, or aggregated as desired.

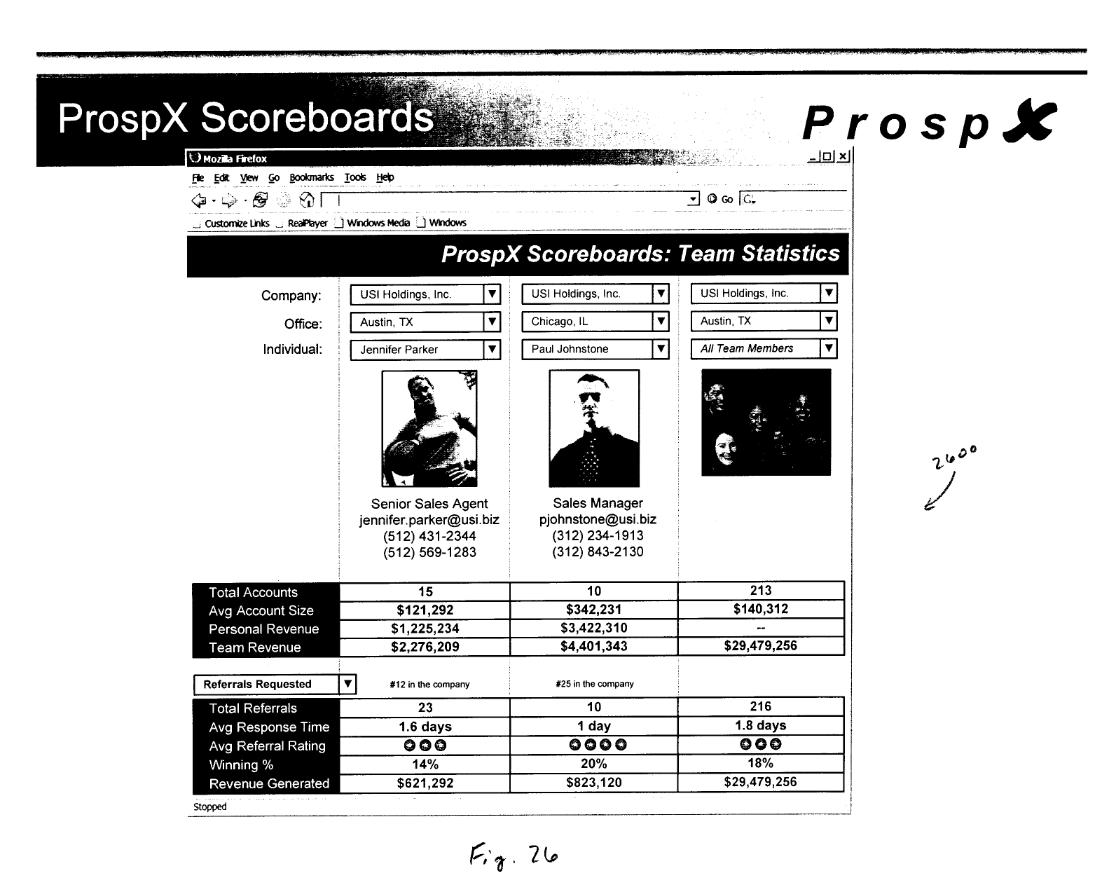

Referring to FIG. 26, other report by the systems and methods includes aggregate and/or relative statistics and credits of users and team members. A team interface 2600, for example, is accessible at the device 108 and displays various relative and relevant information of sales process and success for users and appropriate system accessors.

Other displays are possible in keeping with the foregoing. For examples, as a sales efforts are wound up, at intervals of time or sales process, or otherwise, final or interim feedback interfaces and the like are accessible and viewable and interactively operable at the device 108. The database 104 requests, either automatedly or through invocation, by communication over the network 106 to the device 108, final or other survey and result information. The salesperson user of the device 108 can input data of such information, and otherwise correct and rectify information, via the interfaces. As with other aspects, the information of all interfaces and use thereof is registered and maintained at the database 104 and used in operations.

Other Possibilities

An environment for the foregoing embodiments includes a hosted solution. In such an environment, the systems and methods are operated centrally by a provider. Access to the systems and methods by salespersons via devices are segregated, permitted, or otherwise enabled. The environment operates the systems and methods as a subscription service available to salespersons, in one example.

In another environment, embodiments of the systems and methods are hosted by a product provider. Such an environment allows the product provider to include specific features, steps, and considerations for the particular products of the provider. Additionally, the environment can provide product advertising or information that is valuable to the product provider as a marketing tool or other use. Moreover, database operations and recorded usage data and statistics are available and/or usable by the product provider as desired.

One particular environment is, for example, the insurance industry. In the environment, a particular insurance agency can operate the systems and methods of the embodiments internally, for company or branch use. In other instances, an insurance underwriter, carrier or policy provider operates the systems and methods. In other alternatives, a third party to the transaction, such as a hosting company or provider, operates the systems and methods, and provides access, such as in return for access or usage fees, to the systems and methods. Such a third party host/provider can serve an individual, a company, a broader enterprise such as a cooperative or trade group, or even an entire industry or other public-wide segment. In all such environments, general openness to information or varied accessibility or availability is configured as applicable and desired. The environment in every event allows marketing, promotion and other communicative use to be made from the central host of the carrier to the various devices, and respective salespersons using the devices, for the sales tool.

In application to the insurance industry, a company can host and operate the system for a insurance brokerage firms, insurance carriers or the like, such as in return for fees, compensation, usage or other consideration. The insurance brokerage firms and the insurance carriers, via instructions and directives of the hosting/operating company, can permit those brokers and agents that offer or sell the carrier's products to access and use the system for the sales tool. The insurance brokerage firms can publish information for internal use and use by their specifically selected partners. The insurance carriers can publish information for the benefit of insurance brokers, by making it available to the permitted users, via the system and its operations through the host/operator company. The information can be, for example, related to insurance products, comparisons, sales literature, and other matters. Because of the ability of the system to enable segregation of users, access, information, and features, a host/operator company can make the system available to several carriers, and permit access and make available information as is applicable and desired by the each carrier as to particular users brokers, agencies or the like.

Further examples, and other specific embodiments and possibilities for the embodiments, are provided in the Appendix hereto and included herein.

Of course, a wide variety of alternatives are possible. Additional features can include such matters as content selection, maintenance, timing, backup and other options. Various artificial intelligence and logic can be included in operations. For example, biometrics of emotional aspects of sales/buying, individualized calibrations of processes and operations can be accounted for, and other possibilities. Conflicts between salespersons over credit for efforts and sales attributions sometimes arise in the sales force. The embodiments can include resolution mechanisms in the event of disagreements or disputes, such as identification of such situations, notifications to affected devices/persons, and resolution mechanisms. Various information compiled or used by or in the embodiments can be sorted, aggregated, transferred, sold or otherwise distributed or disposed. In certain environments, salesperson ratings may be transferable on new employment to the hiring company, or the like, or such information can be made available to oversight authorities. Moreover, integrations with current and future applications and available data are possible in the embodiments.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An automated sales process facilitation tool, comprising:
a database of sales and sales process data;
a network connected to the database;
a first salesperson device connected to the network, capable of communicating a token to the database over the network and selectively retrieving to the device over the network a relevant data from among the sales and sales process data of the database;
a second device connected to the network, capable of accessing the token and communicating a feedback data to the database, the feedback data representative of a value of the token; and
a credit attributed to the value of the token by the database, the credit being maintained by the database; and
whereas the database operatively assigns the token to relevant sales situations based on the attributes of the sales situations in which the token as been used
whereas the database operatively ranks the token in accord with the value, to ensure qualitative, relevant and credible sales and sales process data of the database for successive database operations.

2. The system of claim 1, further comprising:
a third device connected to the network, capable of accessing the token and communicating a second feedback data to the database, the second feedback data representative of a second value of the token;
whereas the database processes the value and the next value to obtain a new value, thereby operatively ranking the token in accord with the new value; and
whereas a new credit attributed to the new value is determined and maintained by the database.

3. The system of claim 2, further comprising:
a second token communicated to the database, the second token attributed a second value by the database;
whereas the second token and the token are ranked by the database according to relation of the second value and the new value.

4. A method of facilitating a sales process for a product, comprising the steps of:
providing a database of sales and sales process data;
communicating with the database over a network;
directing the database to sort for a relevant subset of the sales and sales process data of the database;
accessing the relevant subset over the network;
evaluating a data of the relevant subset;
communicating a feedback of a result of the step of evaluating, over the network to the database;
processing the feedback to value the result;
ranking the data of the relevant subset in accordance with the value from the step of processing;
communicating a token having a value over the network to the database;
storing the token as a new data of the sales and process data of the database;
repeating the steps of evaluating, communicating feedback, processing and ranking as to the new data;
accessing the new data as a portion of the relevant subset;
crediting the token, in accordance with the value;
varying the step of ranking after the step of processing; and
varying the step of processing the feedback in accordance with a characteristic of the result.

5. A method of obtaining a preferable sale data for a sales opportunity from among an aggregate of sales data of a database, the preferable sale data has a value to the sales opportunity, comprising the steps of:
populating the database with the aggregate of sales data, the aggregate includes a first preferable sale data that is the preferable sale data;
receiving a feedback by the database communicated over a network, concerning the value to the sales opportunity of the first preferable sale data;
revaluing the first preferable sale data with respect to the aggregate of sales data in response and in accordance to the feedback;
ranking the first preferable sale data with respect to the aggregate of sales data based on the step of revaluing; and
determining a second preferable sale data as the preferable sale data based on the step of ranking.
